(19) United States
(12) Patent Application Publication
(10) Pub. No.: US 2017/0206863 A1
(43) Pub. Date: Jul. 20, 2017

(54) ELECTRONIC DEVICE AND METHOD FOR OPERATING THE SAME

(71) Applicant: Samsung Electronics Co., Ltd., Gyeonggi-do (KR)

(72) Inventors: Sungyoun AN, Gyeonggi-do (KR); Jiwon KIM, Seoul (KR); Hang-Kyu PARK, Seoul (KR); Ochae KWON, Seoul (KR); Dongjun SHIN, Seoul (KR); Bo-Keun KIM, Gyeonggi-do (KR)

(73) Assignee: Samsung Electronics Co., Ltd.

(21) Appl. No.: 15/410,083

(22) Filed: Jan. 19, 2017

(30) Foreign Application Priority Data
Jan. 19, 2016 (KR) 10-2016-0006255

(51) Int. Cl. G09G 5/38; G09G 3/20; G08B 5/36; G06F 1/16

(52) U.S. Cl. CPC G09G 5/38; G06F 1/1652; G06F 1/1677; G09G 3/2092; G08B 5/36; G09G 2340/0492; G06F 1/1694

(57) ABSTRACT

Methods and apparatuses are provided for operating an electronic device. An opening of a flexible display unit from a closed position is sensed. The flexible display unit includes a first display area, a second display area, and a status display area disposed between the first display area and the second display area. An open angle between the first display area and the second display area is determined. Status information, which is to be displayed in the status display area, is determined based on the open angle.

### PRIORITY

This application claims priority under 35 U.S.C. §119(a) to Korean Patent Application Serial No. 10-2016-0006255, which was filed in the Korean Intellectual Property Office on Jan. 19, 2016, the content of which is incorporated herein by reference.

### BACKGROUND

1. Field of the Disclosure

The present disclosure relates generally to an electronic device and a method for operating the same, and more particularly, to a flexible electronic device and a method for operating the flexible electronic device during opening and closing.

2. Description of the Related Art

Recent developments in digital technology have been followed by widespread use of various types of electronic devices, such as, for example, mobile communication terminals, smartphones, tablet personal computers (PCs), personal digital assistants (PDAs), electronic organizers, laptop computers, and wearable devices. The electronic devices have reached a phase of mobile convergence, in which they incorporate the functions of other devices. For example, electronic devices can provide a communication function, including voice communication and video communication, a message transmitting/receiving function, including short message service (SMS)/multimedia messaging service (MMS) and e-mail, an electronic organizer function, an imaging function, a broadcast program playback function, a moving image playback function, a music playback function, an Internet function, a messenger function, a gaming function, and a social networking service (SNS) function.

An electronic device, as described above, can be implemented to be foldable. Particularly, the electronic device can be bent using the center area thereof as a boundary. However, the center area of the electronic device is not used efficiently, in that various interactions cannot be provided through the center area.

### SUMMARY

The present disclosure has been made to address at least the above problems and/or disadvantages and to provide at least the advantages described below. Accordingly, an aspect of the present disclosure provides an electronic device with a flexible display unit.

According to an aspect of the present disclosure, an electronic device is provided that includes a flexible display unit having a first display area, a second display area, and a status display area disposed between the first display area and the second display area. The electronic device also includes a control unit functionally connected to the flexible display unit. The control unit is configured to sense an opening of the display unit from a closed position, to detect an open angle between the first display area and the second display area, and to determine status information, which is to be displayed in the status display area, based on the open angle.

According to another aspect of the present disclosure, a method is provided for operating an electronic device. An opening of a flexible display unit from a closed position is sensed. The flexible display unit includes a first display area, a second display area, and a status display area disposed between the first display area and the second display area. An open angle between the first display area and the second display area is determined. Status information, which is to be displayed in the status display area, is determined based on the open angle.

According to another aspect of the present disclosure, a method is provided for operating an electronic device. An open angle between a first display area of a flexible display unit and a second display area of the flexible display unit is determined. The flexible display unit further comprises a status display area disposed between the first display area and the second display area. Status information is determined based on the open angle. The status information is displayed in the status display area, and at least one screen is displayed in at least one of the first display area and the second display area based on the open angle.

### BRIEF DESCRIPTION OF THE DRAWINGS

The above and other aspects, features, and advantages of the present disclosure will be more apparent from the following detailed description when taken in conjunction with the accompanying drawings, in which:

FIG. 1 is a block diagram illustrating an electronic device, according to an embodiment of the present disclosure;

FIG. 2, FIG. 3A, and FIG. 3B are diagrams illustrating top views of an electronic device, according to an embodiment of the present disclosure;

FIGS. 4A-4F are diagrams illustrating side views of an electronic device, according to an embodiment of the present disclosure;

FIG. 5 is a flowchart illustrating a method of operating an electronic device, according to an embodiment of the present disclosure;

FIG. 6 is a flowchart illustrating a display unit closing operation in connection with FIG. 5, according to an embodiment of the present disclosure;

FIG. 7 is a flowchart illustrating a display unit closing operation in connection with FIG. 5, according to an embodiment of the present disclosure;

FIG. 8 is a flowchart illustrating a status information displaying operation in connection with FIG. 5, according to an embodiment of the present disclosure;

FIG. 9 is a flowchart illustrating a method of displaying the first display area or the second display area in connection with FIG. 8, according to an embodiment of the present disclosure;

FIG. 10 is a flowchart illustrating a method of displaying status information in connection with FIG. 5, according to an embodiment of the present disclosure;

FIG. 11 is a flowchart illustrating a method of displaying status information in connection with FIG. 5, according to an embodiment of the present disclosure;

FIG. 12 is a flowchart illustrating a method of displaying the first display area, the second display area, and the status display area in connection with FIG. 11, according to an embodiment of the present disclosure;

FIG. 13 is a flowchart illustrating a method of displaying status information in connection with FIG. 5, according to an embodiment of the present disclosure;

FIG. 14 is a flowchart illustrating a method of displaying status information in connection with FIG. 5, according to an embodiment of the present disclosure;

FIGS. 15A-15C are diagrams illustrating an electronic device operating method, according to an embodiment of the present disclosure;

FIGS. 16A-16G are diagrams illustrating an electronic device operating method, according to an embodiment of the present disclosure;

FIGS. 17A-17G are diagrams illustrating an electronic device operating method, according to an embodiment of the present disclosure;

FIGS. 18A-18G are diagrams illustrating an electronic device operating method, according to an embodiment of the present disclosure;

FIGS. 19A and 19B are diagrams illustrating an electronic device operating method, according to an embodiment of the present disclosure;

FIGS. 20A-20H are diagrams illustrating an electronic device operating method, according to an embodiment of the present disclosure;

FIGS. 21A-21F are diagrams illustrating an electronic device operating method, according to an embodiment of the present disclosure;

FIGS. 22A-22C are diagrams illustrating an electronic device operating method, according to an embodiment of the present disclosure;

FIG. 23 is a flowchart illustrating an electronic device operating method, according to an embodiment of the present disclosure;

FIGS. 24A and 24B are diagrams illustrating an electronic device operating method, according to an embodiment of the present disclosure;

FIG. 25 is a flowchart illustrating an electronic device operating method, according to an embodiment of the present disclosure;

FIGS. 26A-26D are diagrams illustrating an electronic device operating method, according to an embodiment of the present disclosure;

FIG. 27 is a flowchart illustrating an electronic device operating method, according to an embodiment of the present disclosure; and

FIGS. 28A-28C are diagrams illustrating an electronic device operating method, according to an embodiment of the present disclosure.

### DETAILED DESCRIPTION

Embodiments of the present disclosure are described in detail with the accompanying drawings. The same or similar components may be designated by the same or similar reference numerals although they are illustrated in different drawings. Detailed descriptions of constructions or processes known in the art may be omitted to avoid obscuring the subject matter of the present disclosure.

As used herein, the expressions “have”, “may have”, “include”, and “may include” refer to the existence of a corresponding feature (e.g., numeral, function, operation, or constituent element such as component), and do not exclude the inclusion of one or more additional features.

In the present disclosure, expressions such as “A or B,” “at least one of A and B,” or “one or more of A and B” may include all possible combinations of the listed items. For example, the above expressions refer to all of (1) including at least one A, (2) including at least one B, or (3) including at least one A and at least one B.

Expressions such as “first,” “second,” “primarily,” and “secondary,” as used herein, may represent various elements regardless of order and/or importance and do not limit corresponding elements. The expressions may be used for distinguishing one element from another element. When it is described that an element (such as a first element) is “(operatively or communicatively) coupled” to or “connected” to another element (such as a second element), the element can be directly connected to the other element or can be connected through another element (such as a third element).

An expression “configured to (or set)”, as used herein, may be used interchangeably with, for example, “suitable for,” “having the capacity to,” “designed to,” “adapted to,” “made to,” or “capable of” according to the situation. The expression “configured to (or set)” does not only mean “specifically designed to” by hardware. Alternatively, in some situations, the expression “apparatus configured to” may mean that the apparatus “can” operate together with another apparatus or component. For example, a phrase “a processor configured (or set) to perform A, B, and C” may be a generic-purpose processor (such as a central processing unit (CPU) or an application processor (AP)) that can perform a corresponding operation by executing at least one software program stored at an exclusive processor (such as an embedded processor) for performing a corresponding operation or at a memory device.

The terms as used herein are used merely to describe certain embodiments and are not intended to limit the present disclosure. As used herein, singular forms may include plural forms as well, unless the context explicitly indicates otherwise. All terms used herein, including technical and scientific terms, have the same meanings as those commonly understood by those of skill in the art which the present disclosure pertains. Such terms as those defined in a generally used dictionary are to be interpreted to have meanings equivalent to the contextual meanings in the relevant field of art, and are not to be interpreted to have ideal or excessively formal meanings unless clearly defined in various embodiments of the present disclosure. In some cases, even a term defined in the present disclosure should not be interpreted to exclude embodiments of the present disclosure.

An electronic device, according to embodiments of the present disclosure, may include at least one of, for example, a smart phone, a tablet PC, a mobile phone, a video phone, an electronic book reader (e-book reader), a desktop PC, a laptop PC, a netbook computer, a workstation, a server, a PDA, a portable multimedia player (PMP), an MPEG-1 audio layer-3 (MP3) player, a mobile medical device, a camera, and a wearable device. The wearable device may include at least one of an accessory type (e.g., a watch, a ring, a bracelet, an anklet, a necklace, a glasses, a contact lens, or a head-mounted device (HIVID)), a fabric or clothing integrated type (e.g., an electronic clothing), a body-mounted type (e.g., a skin pad, or tattoo), and a bio-implantable type (e.g., an implantable circuit). The wearable electronic device may be a flexible electronic device.

In the present disclosure, the term “user” may indicate a person using an electronic device or a device (e.g., an artificial intelligence electronic device) using an electronic device. An electronic device may be a flexible electronic device and may be a wearable electronic device.

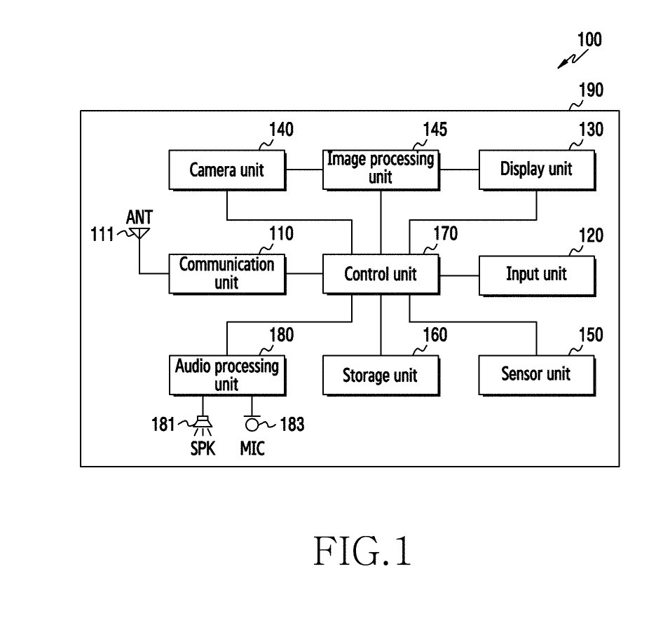

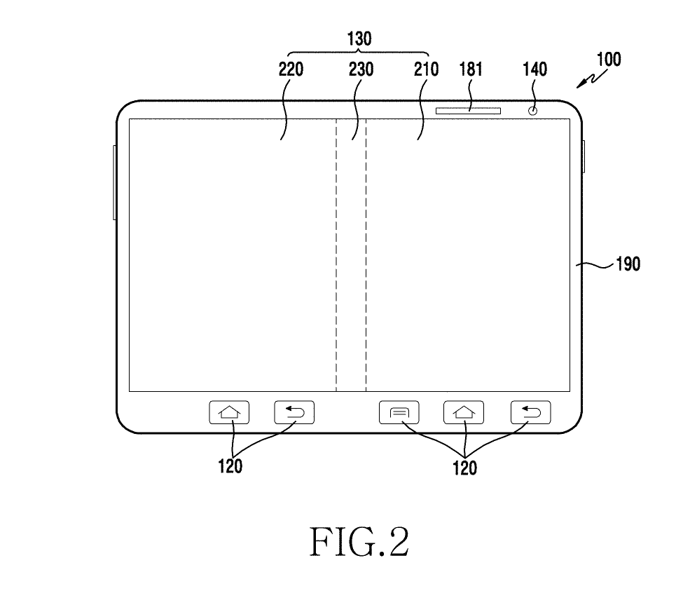

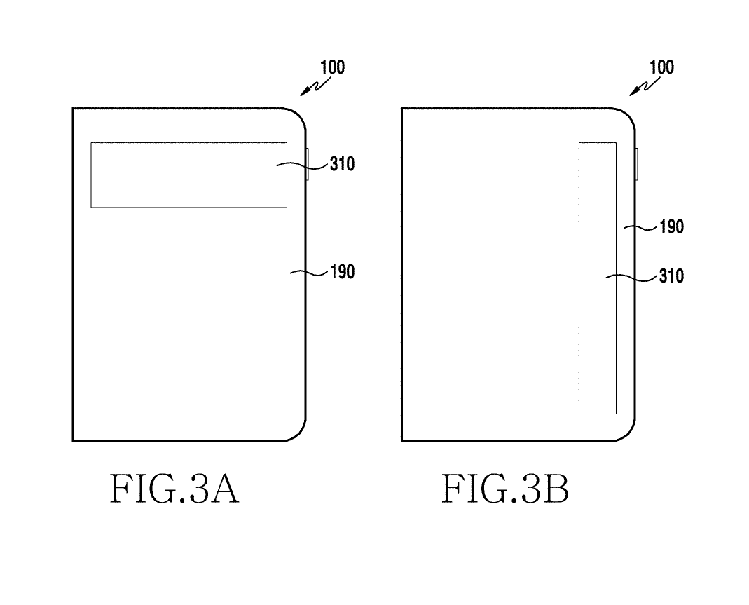

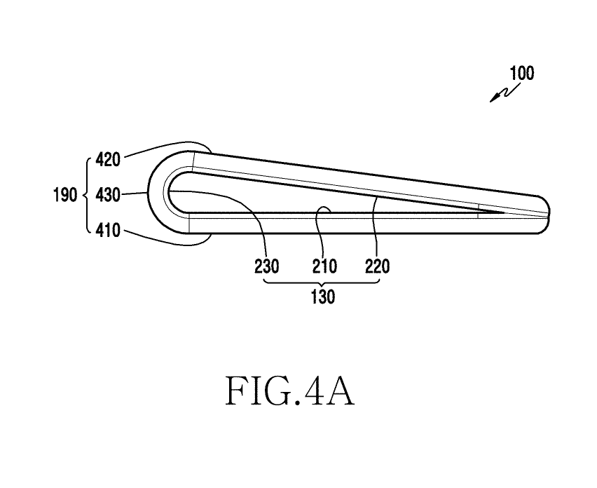

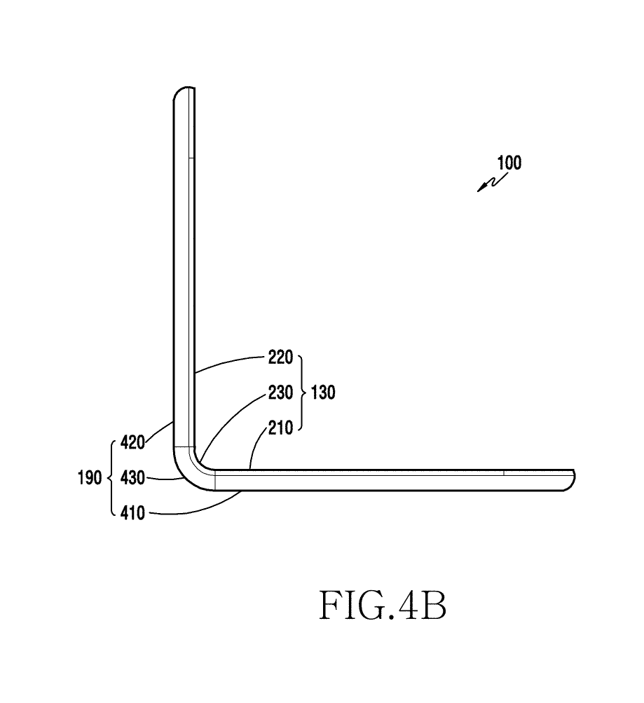

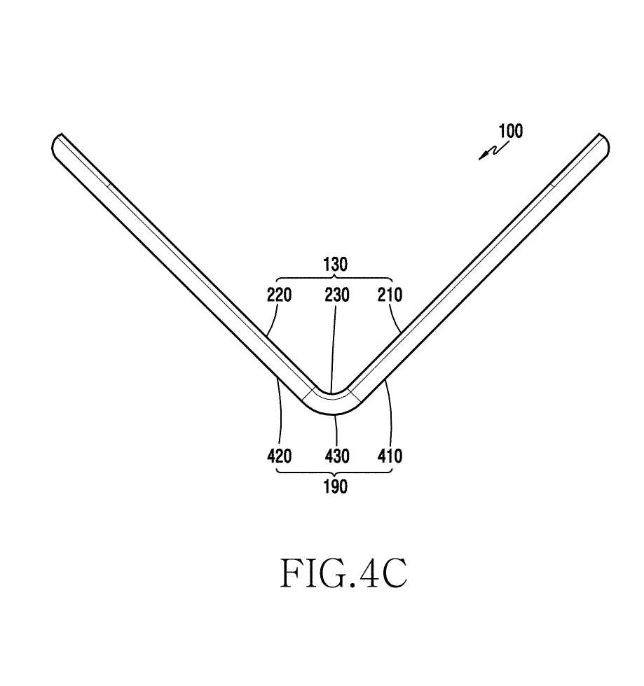

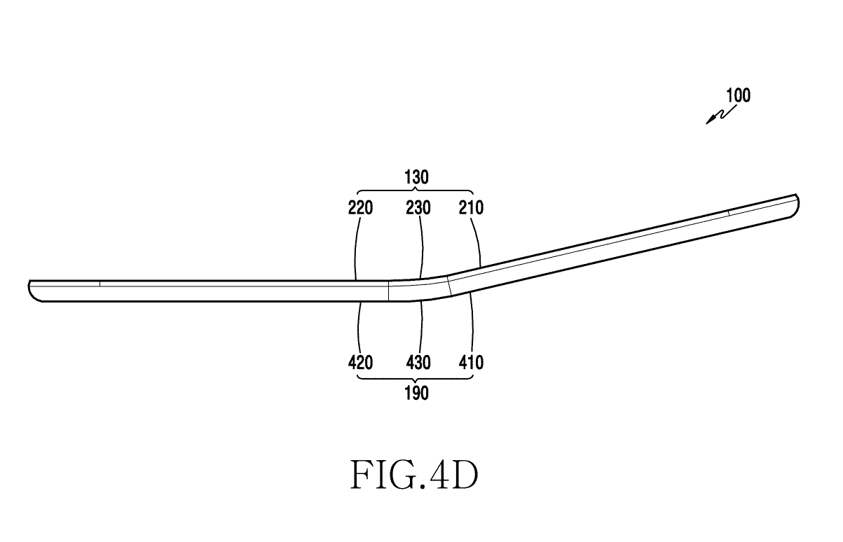

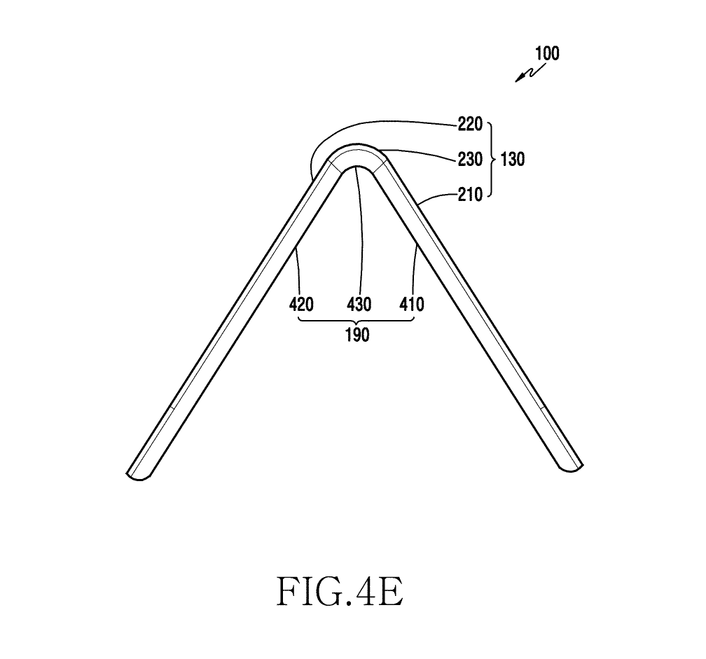

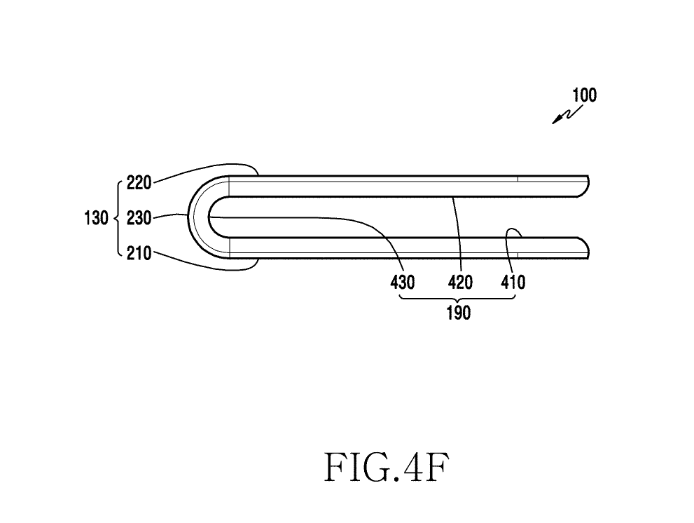

FIG. 1 is a block diagram illustrating an electronic device, according to an embodiment of the present disclosure. FIGS. 2, 3A, and 3B are diagrams illustrating top views of an electronic device, according to an embodiment of the present disclosure. FIGS. 4A-4F are diagrams illustrating side views of an electronic device, according to an embodiment of the present disclosure.

Referring to FIG. 1, an electronic device 100 includes a communication unit 110, an input unit 120, a display unit 130, a camera unit 140, an image processing unit 145, a sensor unit 150, a storage unit 160, a control unit 170, an audio processing unit 180, and a housing 190. The electronic device 100 may be a foldable device.

The communication unit 110 can perform communication in the electronic device 100. In this case, the communication unit 110 may communicate with an external device in various communication schemes. For example, the communication unit 110 may conduct communication in a wired or wireless manner. To this end, the communication unit 110 may include at least one antenna (ANT) 111. In addition, the communication unit 110 may access at least one of a mobile communication network and a data communication network through the antenna 111. Alternatively, the communication unit 110 can perform short-range communication. For example, the external device may include an electronic device, a base station, a server, and a satellite. Furthermore, the communication scheme may include long term evolution (LTE), wideband code division multiple access (WCDMA), global system for mobile communications (GSM), wireless fidelity (WiFi), wireless local area network (LAN), Bluetooth, and near field communications (NFC).

The input unit 120 can generate input data in the electronic device 100. In this case, the input unit 120 can generate input data in response to the user's input made through the electronic device 100. Furthermore, the input unit 120 may include at least one input means. The input unit 120 may include a key pad, a dome switch, a physical button, a touch panel, a jog & shuttle, and a sensor. For example, the input unit 120 may include a power key.

The display unit 130 may output display data in the electronic device 100. The display unit 130 may be driven using a self-light-emitting phenomenon. The display unit 130 may include an organic light emitting diode (OLED) display and an active matrix light emitting diode (AMOLED). The display unit 130 may be coupled to the input unit 120 and implemented as a touch screen. The display unit 130 may be a flexible display unit that has flexibility.

The display unit 130 includes, as illustrated in FIG. 2, a first display area 210, a second display area 220, and a status display area 230. The first display area 210, the second display area 220, and the status display area 230 are arranged on the front surface of the electronic device 100. The status display area 230 is arranged between the first display area 210 and the second display area 220. At least one of the first display area 210 and the second display area 220 may rotate about the center line of the status display area 230 between the first display area 210 and the second display area 220. Through this process, the display unit 130 may be closed and may also be opened. To this end, the shape of the status display area 230 in the display unit 130 may be changed.

The display unit 130 may be closed as illustrated in FIG. 4A, and may be opened as illustrated in FIGS. 4B-4F. When the display unit 130 is closed, the first display area 210, the second display area 220, and the status display area 230 may face one another. To this end, the angle between the first display area 210 and the second display area 220 is less than or equal to 0°. On the other hand, when the display unit 130 is opened, the angle between the first display area 210 and the second display area 220 is greater than 0°. Herein, the angle between the first display area 210 and the second display area 220 may be used interchangeably with the term “open angle”.

For example, the open angle may be determined to be in a range that is greater than 0° and is less than or equal to 360°. The open angle may be defined with reference to a first angle range, a second angle range, a third angle range, a fourth angle range, and a fifth angle range. When the open angle is included in the first angle range, the display unit 130 may be opened in such a shape as illustrated in FIG. 4B. When the open angle is included in the second angle range, the display unit 130 may be opened in such a shape as illustrated in FIG. 4C. When the open angle is included in the third angle range, the display unit 130 may be opened in such a shape as illustrated in FIG. 4D. When the open angle is included in the fourth angle range, the display unit 130 may be opened in such a shape as illustrated in FIG. 4E. When the open angle is included in the fifth angle range, the display unit 130 may be opened in such a shape as illustrated in FIG. 4F. The first angle range is greater than 0° and less than or equal to 90°; the second angle range is greater than 90° and less than or equal to 170°; the third angle range is greater than 170° and less than or equal to 190°; the fourth angle range is greater than 190° and less than or equal to 330°; and the fifth angle range is greater than 330° and less than or equal to 360°.

The display unit 130 may further include a sub display area 310 as illustrated in FIGS. 3A and 3B. The sub display area 310 is arranged on the rear surface of the electronic device 100. Accordingly, the sub display area 310 can be exposed even when the display unit 130 is closed. For example, the sub display area 310 may have various shapes as illustrated in FIG. 3A or FIG. 3B.

The camera unit 140 may generate image data in the electronic device 100. To this end, the camera unit 140 may receive an optical signal. In addition, the camera unit 140 may generate image data from the optical signal. The camera unit 140 may include a camera sensor and a signal conversion unit. The camera sensor may convert the optical signal to an electric image signal. The signal conversion unit can convert an analog image signal to digital image data.

The image processing unit 145 may process image data in the electronic device 100. In this case, the image processing unit 145 may process the image data with regard to each frame and may output the same so as to correspond to the characteristics and size of the display unit 130. The image processing unit 145 may compress the image data according to a preset scheme or may restore compressed image data to the original image data.

The sensor unit 150 may sense the status of the electronic device 100. Alternatively, the sensor unit 150 may measure the peripheral physical quantity of the electronic device 100. In other words, the sensor unit 150 may detect a physical signal. In addition, the sensor unit 150 may convert the physical signal to an electric sensing signal. The sensor unit 150 may include at least one sensor. For example, the sensor unit 150 may include at least one of a gesture sensor, a gyro sensor, a barometer, a magnetic sensor, an acceleration sensor, a grip sensor, a proximity sensor, a color sensor, a medical sensor, a temperature/humidity sensor, an illuminance sensor, and an ultra violet (UV) sensor.

According to embodiments of the present disclosure, the sensor unit 150 may sense a motion of the display unit 130. In this case, the sensor unit 150 may separately sense a motion of the first display area 210 and a motion of the second display area 220. To this end, the sensor unit 150 may include a first motion sensor and a second motion sensor. The first motion sensor may be arranged to correspond to the first display area 210, and the second motion sensor may be arranged to correspond to the second display area 220.

The storage unit 160 can store operation programs of the electronic device 100. The storage unit 160 may store a program for controlling display data according to the open angle of the display unit 130. Furthermore, the storage unit 160 may store data generated while the programs are executed.

The control unit 170 may control the overall operation in the electronic device 100. The control unit 170 may perform various functions. To this end, the control unit 170 may control the elements of the electronic device 100. In addition, the control unit 170 may receive commands or data from the elements of the electronic device 100 and process the same.

According to embodiments of the present disclosure, the storage unit 170 may control display data according to the open angle of the display unit 130. Particularly, the control unit 170 may sense closing of the display unit 130 and may sense opening of the display unit 130, which has been closed. Furthermore, the control unit 170 may detect the open angle of the display unit 130. In this case, the control unit 170 may detect the open angle of the display unit 130 based on a motion of the display unit 130. For example, the control unit 170 may calculate the open angle between the first display area 210 and the second display area 220 based on a motion of at least one of the first display area 210 and the second display area 220. Furthermore, the control unit 170 may output display data based on the open angle of the display unit 130. In this case, the control unit 170 may determine status information, which is to be displayed in the status display area 230, according to the open angle of the display unit 130. In this regard, the control unit 170 may display status information in the status display area 230, according to the open angle of the display unit 130, or may display status information on an end of the display unit 130.

The audio processing unit 180 may process an audio signal in the electronic device 100. In this regard, the audio processing unit 180 includes a speaker (SPK) 181 and a microphone (MIC) 183. Particularly, the audio processing unit 180 may reproduce an audio signal through the speaker 161. Furthermore, the audio processing unit 180 may collect an audio signal through the microphones 183.

The housing 190 may support and protect elements of the electronic device 100. To this end, the housing 190 may contain elements of the electronic device 100 and may expose the same to the outside. In this case, the housing 190 may be fastened to the rear surface of the display unit 130. The housing 190 may be a foldable housing that has flexibility.

According to embodiments of the present disclosure, the housing 190 includes a first housing 410, a second housing 420, and a third housing 430, as illustrated in FIGS. 4A-4F. The first housing 410 may be fastened to the first display area 210, and the second housing 420 may be fastened to the second display area 220. In this case, the first housing 410 and the second housing 420 may be made of a solid material. The third housing 430 may be arranged between the first housing 410 and the second housing 420 and may be connected to the first housing 410 and the second housing 420. The third housing 430 may be made of a deformable material.

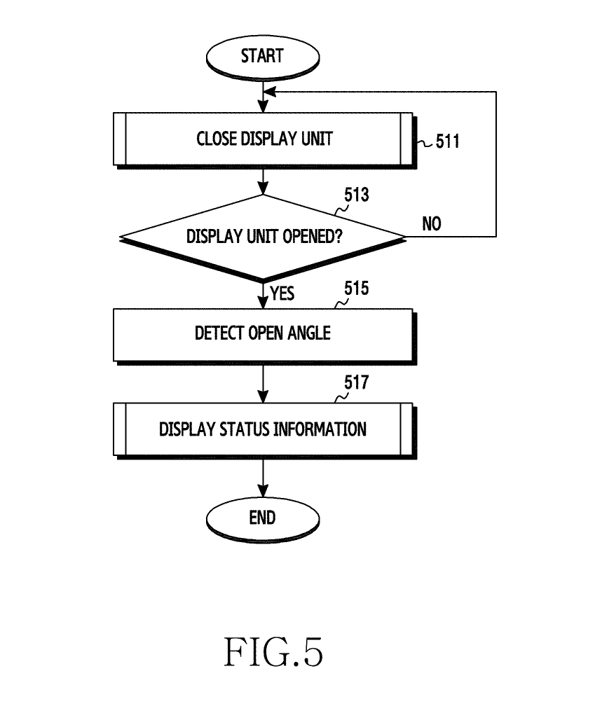

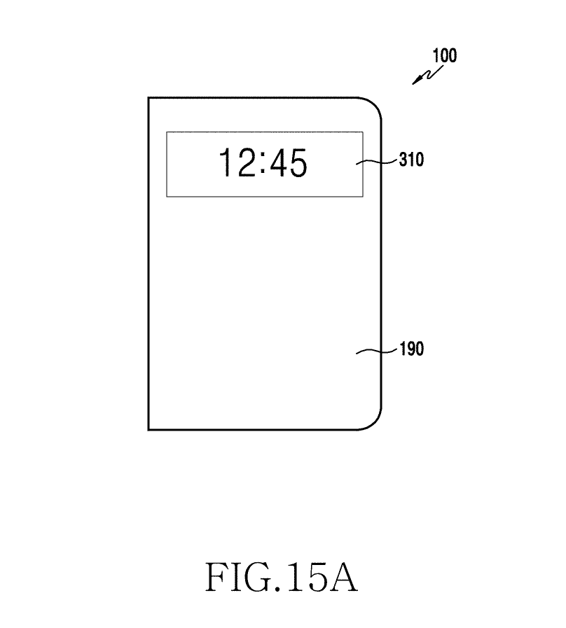

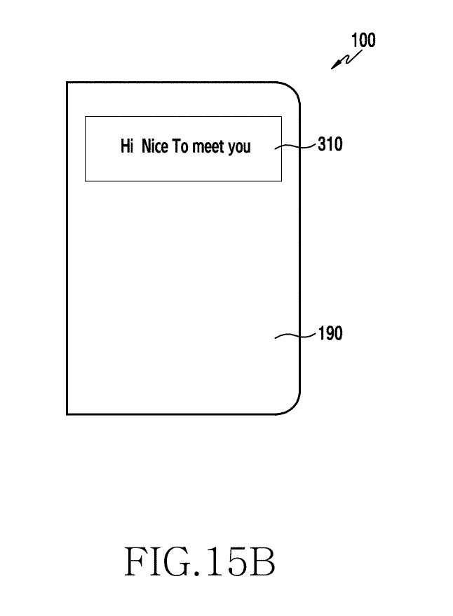

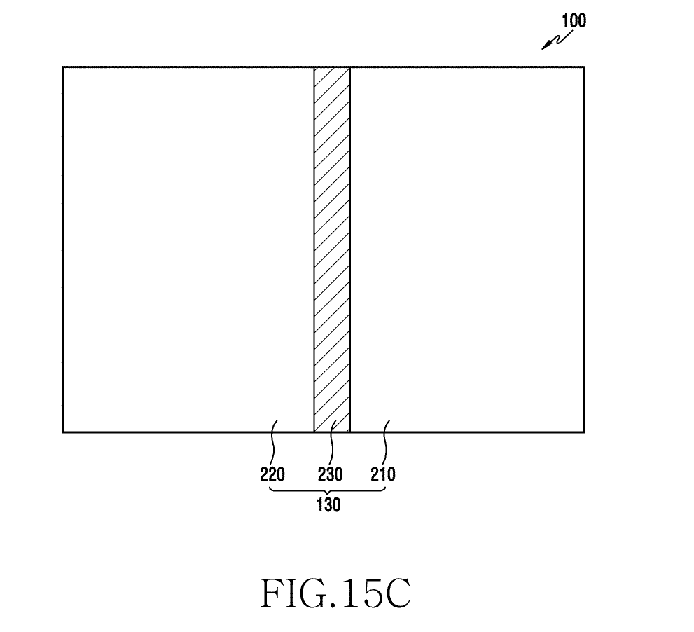

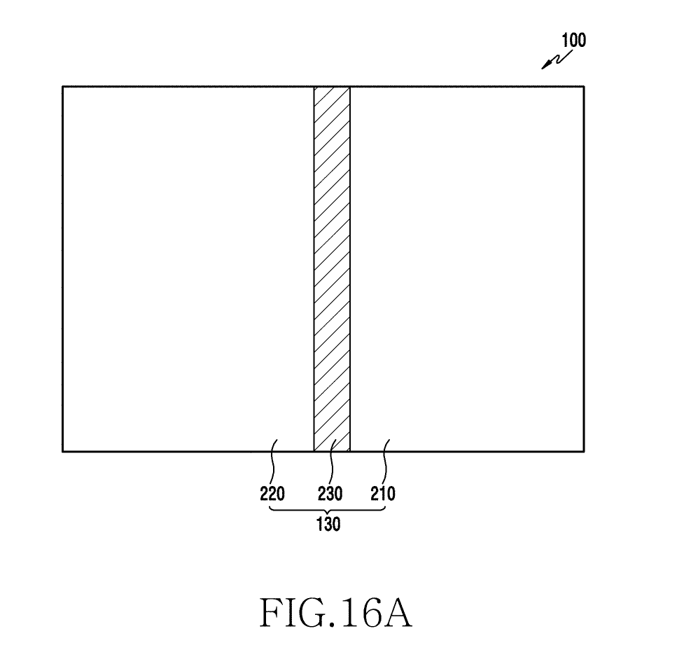

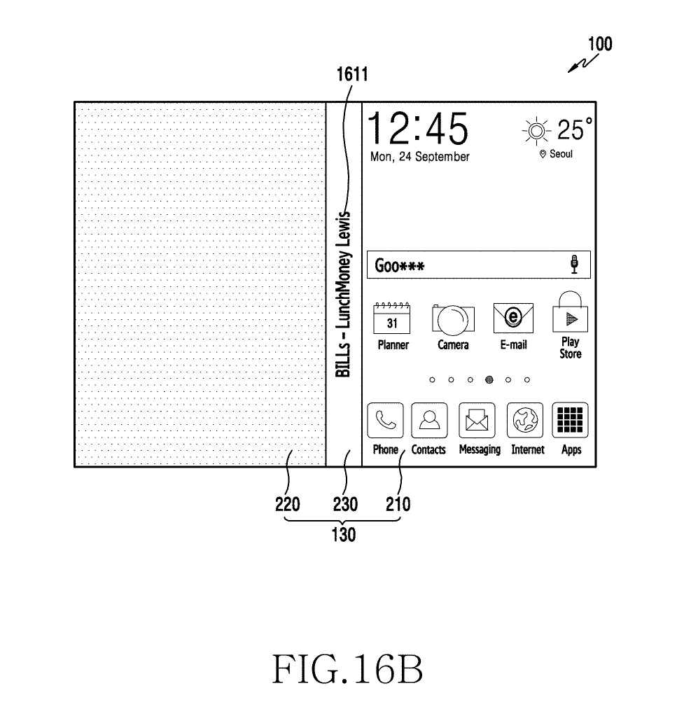

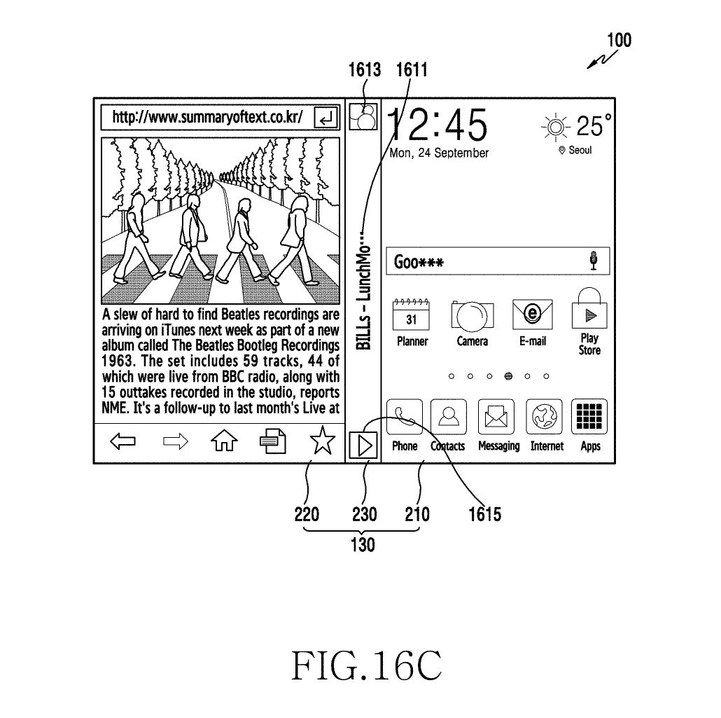

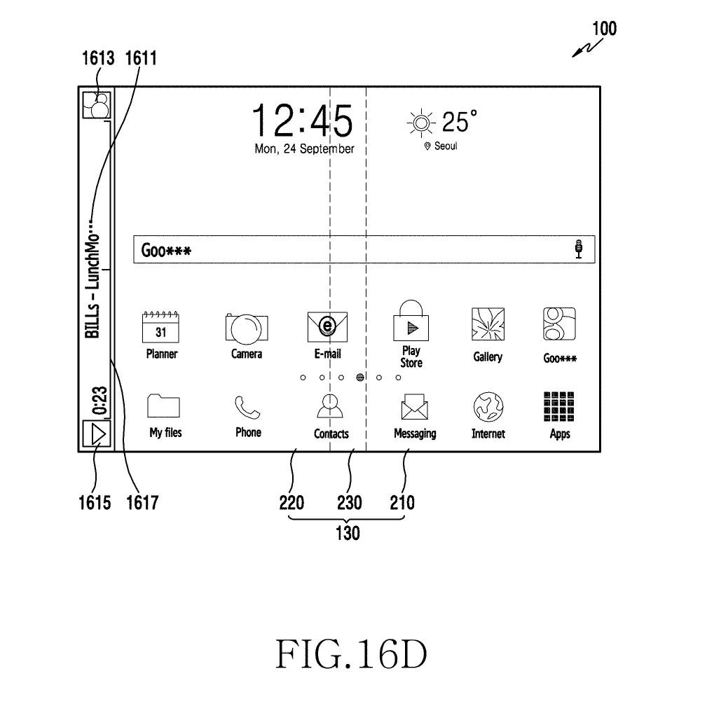

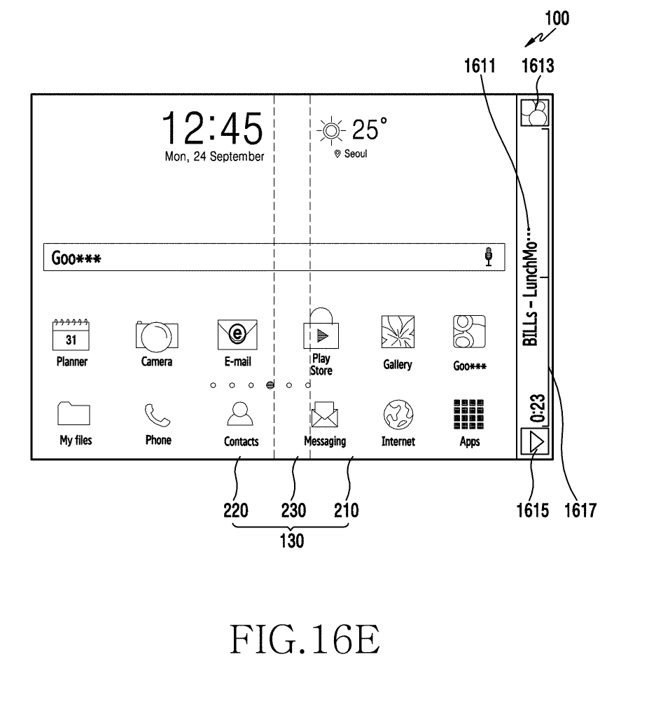

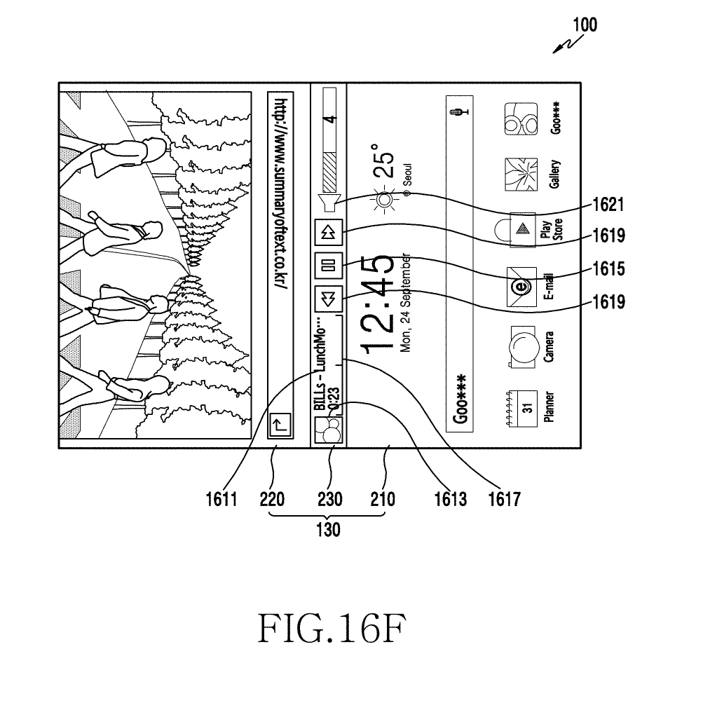

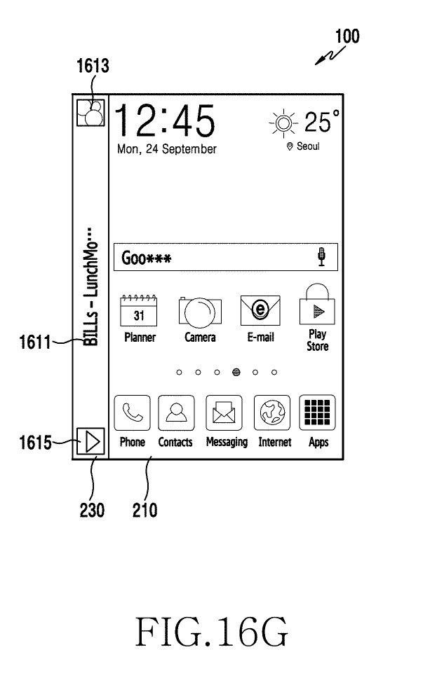

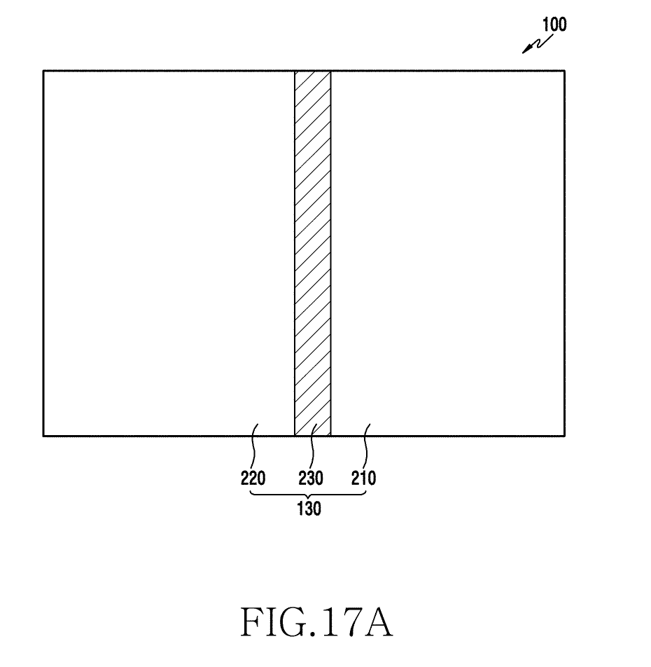

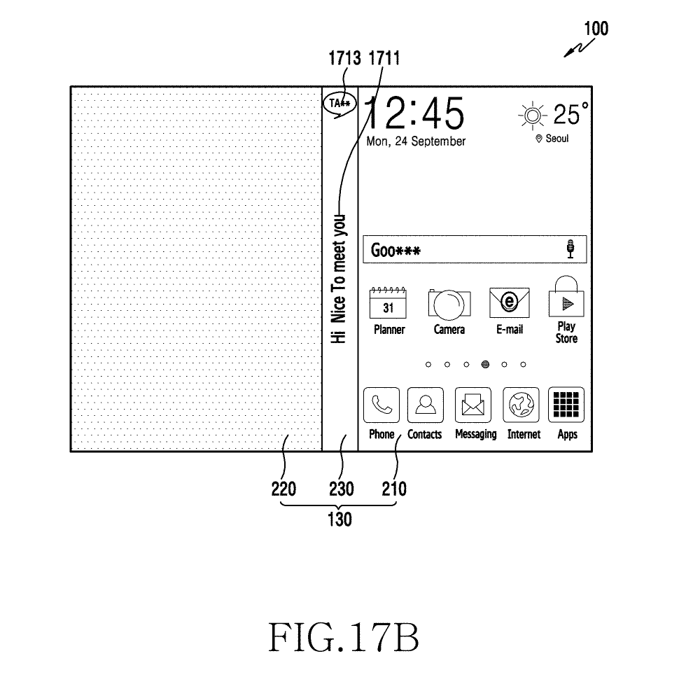

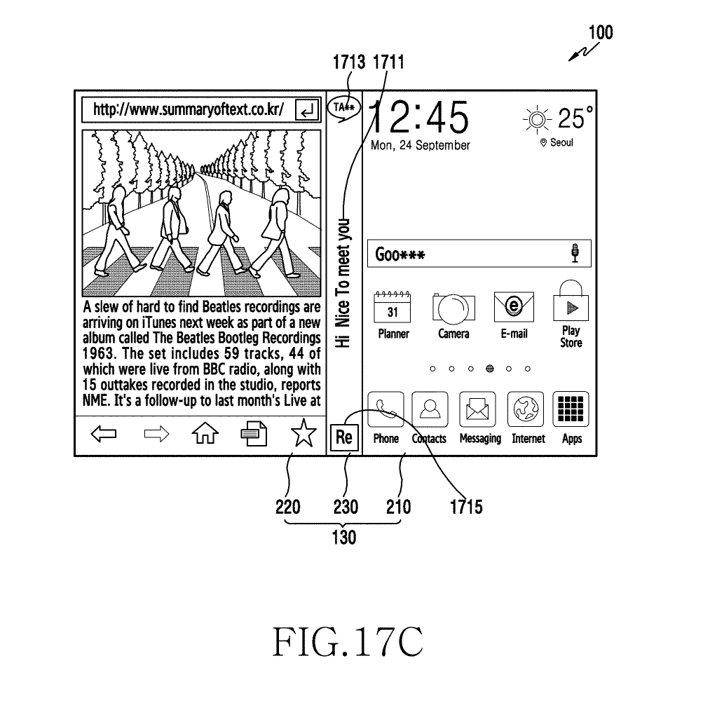

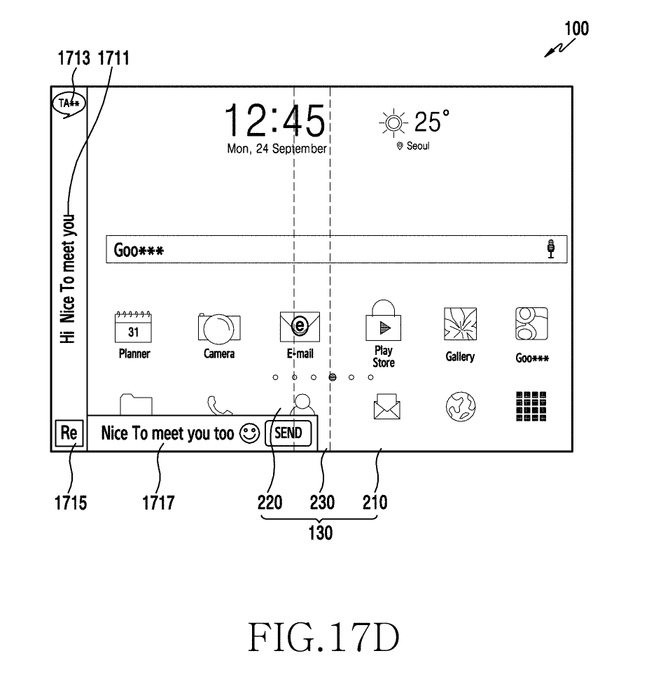

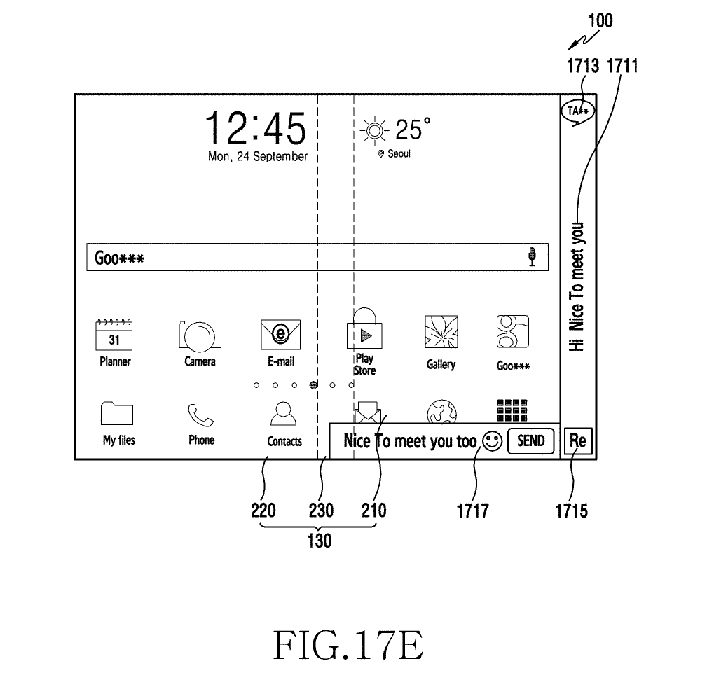

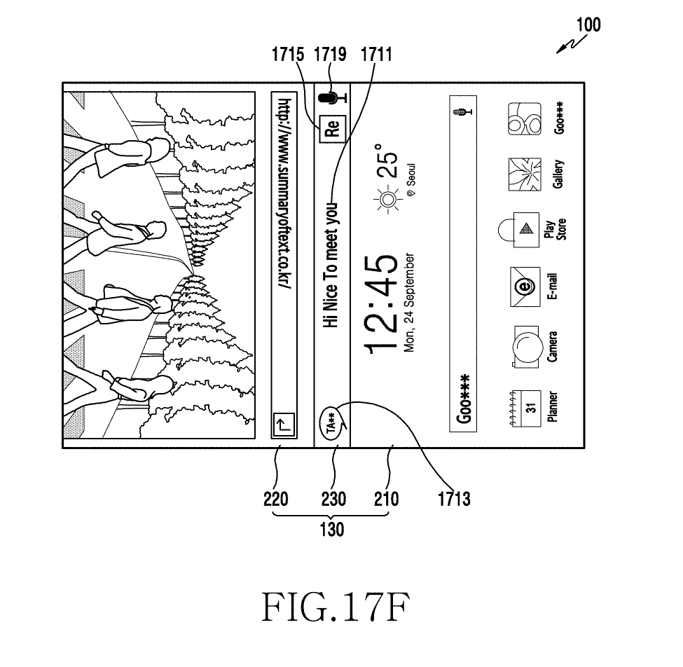

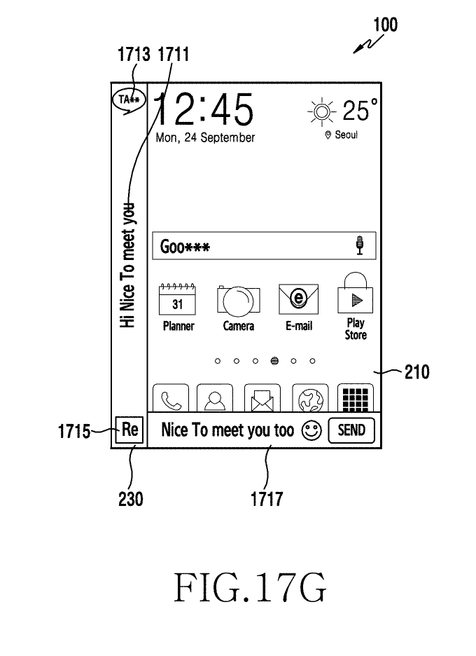

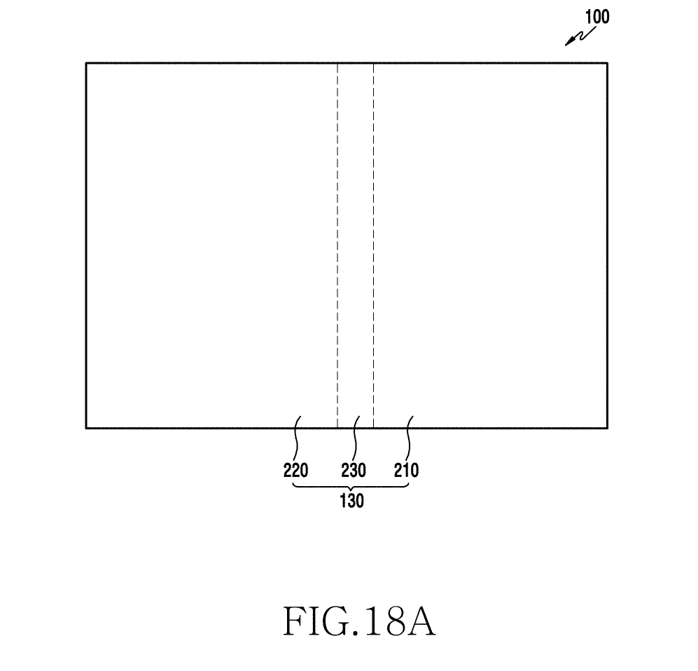

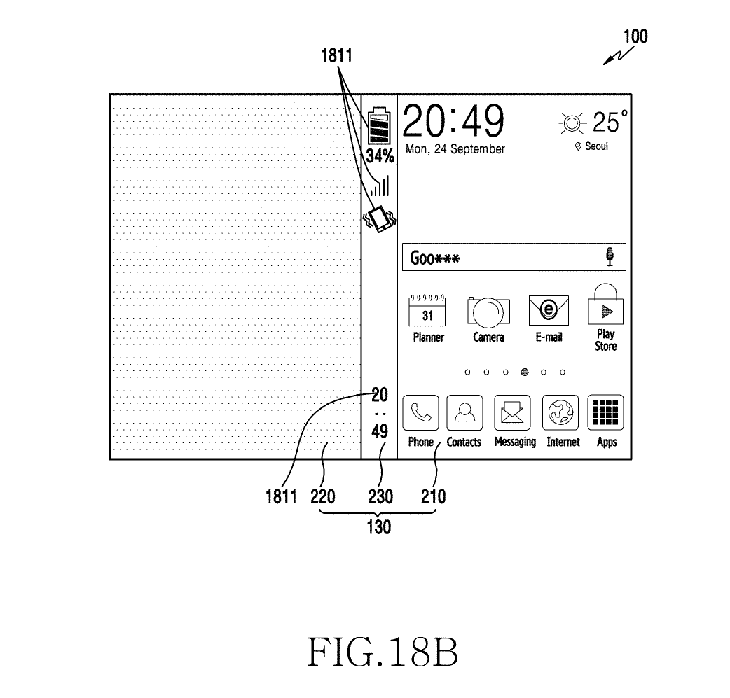

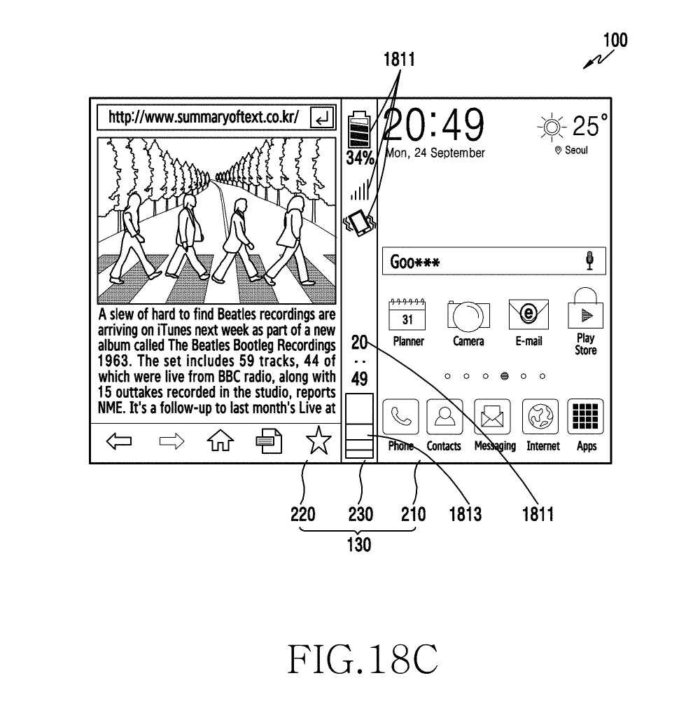

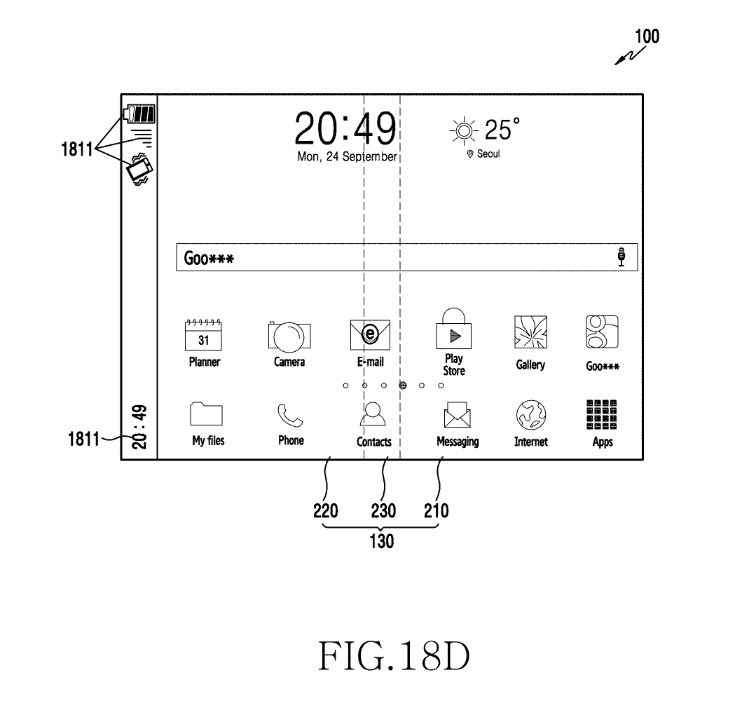

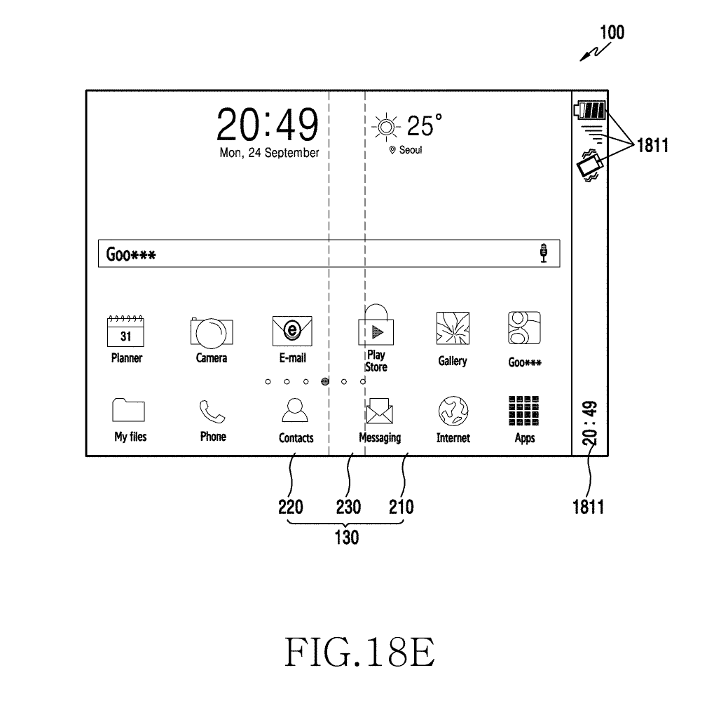

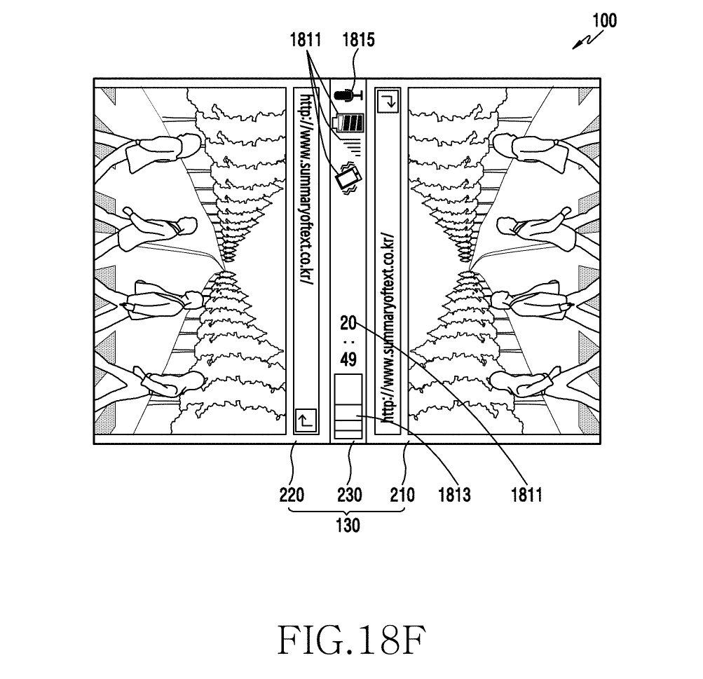

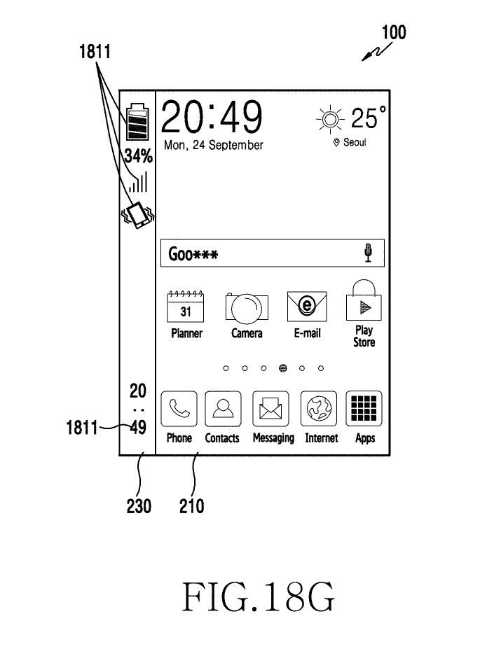

FIG. 5 is a flowchart illustrating an electronic device operating method, according to an embodiment of the present disclosure. FIGS. 15A, 15C are diagrams illustrating an electronic device operating method, according to an embodiment of the present disclosure. FIGS. 16A-16G are diagrams illustrating an electronic device operating method, according to an embodiment of the present disclosure. FIGS. 17A, 17G are diagrams illustrating an electronic device operating method, according to an embodiment of the present disclosure. FIGS. 18A, FIG. 18B, FIG. 18C, FIG. 18D, 18G are diagrams illustrating an electronic device operating method, according to an embodiment of the present disclosure.

Referring to FIG. 5, a method for operating the electronic device 100 begins with sensing the closing of the display unit 130 by the control unit 170, in step 511. The control unit 170 may sense a motion of the display unit 130 through the sensor unit 150. When the display unit 130 is closed, as illustrated in FIG. 4A, the control unit 170 may sense the same. For example, the control unit 170 may sense a motion of at least one of the first display area 210 and the second display area 220 through the sensor unit 150. Furthermore, the control unit 170 may calculate the open angle between the first display area 210 and the second display area 220 based on a motion of at least one of the first display area 210 and the second display area 220. In this regard, the control unit 170 may determine that the display unit 130 is closed, when the angle between the first display area 210 and the second display area 220 is less than or equal to 0°.

The control unit 170 may turn the display unit 130 off when the display unit 130 is closed. The control unit 170 may turn off the first display area 210, the second display area 220, and the status display area 230. Particularly, the control unit 170 may a block power supply to the first display area 210, the second display area 220, and the status display area 230. Alternatively, the control unit 170 may turn off the first display area 210 and the second display area 220, and may turn on the status display area 230. Particularly, the control unit 170 may block a power supply to the first display area 210 and the second display area 220, and may supply power to the status display area 230. For example, when the display unit 130 is closed while a function is being executed, the control unit 170 may turn off the first display area 210 and the second display area 220, and may turn on the status display area 230.

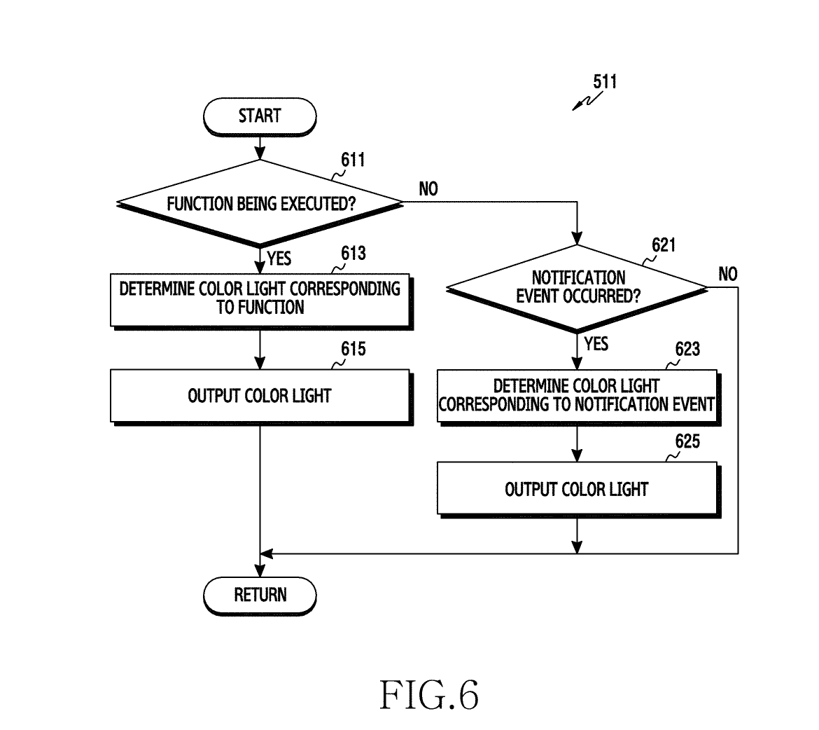

FIG. 6 is a flowchart illustrating a display unit closing operation in connection with FIG. 5, according to an embodiment of the present disclosure.

Referring to FIG. 6, when the display unit 130 is closed, the control unit 170 determines, in step 611, whether a function is being executed or not. Particularly, the control unit 170 may determine whether a function is continuously executed or not, although the display unit 130 is closed.

When it is determined that a function is being executed, the control unit 170 determines a light color, which corresponds to the function, in step 613. In this case, the control unit 170 may determine at least one of the color of the light, the output time interval, the output intensity, and the output type, according to the function. In addition, the control unit 170 outputs a color in the status display area 230 of the display unit 130, in step 615. In this case, when the status display area 230 is turned off, the control unit 170 may turn on the status display area 230 and light. For example, when a music file playing function is being executed, the control unit 170 may output green light in the status display area 230 and may blink the green light according to the music file playing beat. Thereafter, the control unit 170 may return to FIG. 5.

When it is determined in step 611 that no function is being executed, the control unit 170 may stand by. It is determined whether a notification event occurs while in standby, in step 621. In this case, the notification event may include a communication event and a schedule event. For example, the communication event may occur in response to reception of a call, a message, or power. The schedule event may occur in response to arrival of a schedule or an alarm time.

When the notification event occurs, the control unit 170 determines a light color, which corresponds to the notification event, in step 623. In this case, the control unit 170 may determine at least one of the color of the light, the output time interval, the output intensity, and the output type, according to the notification event. In addition, the control unit 170 outputs the color in the status display area 230 of the display unit 130, in step 625. In this case, when the status display area 230 is opened, the control unit 170 may turn on the status display area 230 and output light. For example, the control unit 170 may output yellow light in the status display area 230 in response to originator A. Alternatively, the control unit 170 may output blue light in the status display area 230 in response to originator B. Alternatively, when a call is received, the control unit 170 may output green light in the status display area 230. Alternatively, when power is received, the control unit 170 may output red light in the status display area 230. Thereafter, the control unit 170 may return to FIG. 5.

When the notification event does not occur, the method of FIG. 6 terminates and the control unit may return to FIG. 5.

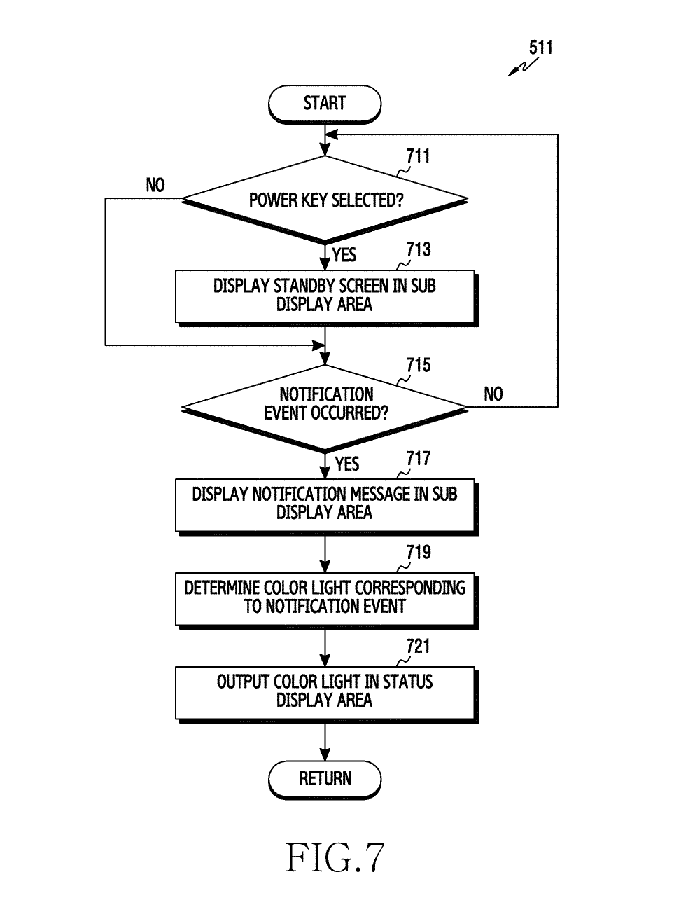

FIG. 7 is a flowchart illustrating a display unit closing operation in connection with FIG. 5, according to an embodiment of the present disclosure.

Referring to FIG. 7, when the display unit 130 is closed, the control unit 170 may stand by. The control unit 170 determines whether a power key is selected during the standby, in step 711. When the power key is selected, the control unit 170 displays a standby screen in the sub display area 310, in step 713. In this case, when the sub display area 310 is turned off, the control unit 170 may turn on the sub display area 310 and display a standby screen. The control unit 170 may display a standby screen in the sub display area 310, as illustrated in FIG. 15A. The control unit 170 may display the standby screen for a preset time interval and then turn off the sub display area 310.

When the power key is not selected, the control unit 170 proceeds directly to step 715. The control unit 170 determines whether a notification event occurs, in step 715. In this case, the notification event may include a communication event and a schedule event. For example, the communication event may occur in response to reception of a call, a message, or power. The schedule event may occur in response to arrival of a schedule or an alarm time. When a notification event has not occurred, the control unit 170 returns to step 711. When a notification event has occurred, the control unit 170 displays a notification message in the sub display area 310, in step 717. In this case, if the sub display area 310 is turned off, the control unit 170 may turn on the sub display area 310 and display a notification message. According to various embodiments, the control unit 170 may display a notification message in the sub display area 310, as illustrated in FIG. 15B.

Thereafter, the control unit 170 determines a color of a light, which corresponds to the notification event, in step 719. In this case, the control unit 170 may determine at least one of the color of the light, the output time interval, the output intensity, and the output type, according to the notification event. In addition, the control unit 170 outputs the color light in the status display area 230 of the display unit 130, in step 721. In this case, when the status display area 230 is turned off, the control unit 170 may turn on the status display area 230 and output color light. The control unit 170 may output color light in the status display area 230, as illustrated in FIG. 15C. For example, the control unit 170 may output a yellow light in the status display area 230 in response to originator A. Alternatively, the control unit 170 may output a blue light in the status display area 230 in response to originator B. Alternatively, when a call is received, the control unit 170 may output a green light in the status display area 230. Alternatively, when power is received, the control unit 170 may output a red light in the status display area 230. Thereafter, the control unit 170 may return to FIG. 5.

Referring back to FIG. 5, the control unit 170 determines whether the display unit is opened, in step 513. In this case, the control unit 170 may sense a motion of the display unit 130 through a sensor unit 150. For example, the control unit 170 may sense a motion of at least one of the first display area 210 and the second display area 220.

If the display unit is not opened, the control unit 170 returns to step 511. If the display unit is opened, the control unit 170 detects the open angle of the display unit 130, in step 515. In this case, if the motion of the display unit 130 stops, the control unit 170 may detect the open angle of the display unit 130. As the display unit 130 is opened as illustrated in one of FIGS. 4B-4F, the control unit 170 detects the open angle of the display unit 130. For example, the control unit 170 may calculate the angle between the first display area 210 and the second display area 220, i.e., the open angle, based on a motion of at least one of the first display area 210 and the second display area 220. For example, the open angle may be determined in a range that is greater than 0° and is less than or equal to 360°.

Finally, the control unit 170 displays status information through the display unit 130, in step 517. To this end, the control unit 170 may determine the status information according to the open angle of the display unit 130. In this case, the control unit 170 may compare the open angle of the display unit 130 with a first angle range, a second angle range, a third angle range, a fourth angle range, and a fifth angle range, which have been determined in advance. In addition, the control unit 170 may display status information in the status display area 230, according to the open angle of the display unit 130, and may display status information on an end of the display unit 130. Furthermore, the control unit 170 may display at least one screen through the display unit 130. For example, the control unit 170 may display at least one screen in at least one of the first display area 210 and the second display area 220. Alternatively, the control unit 170 may display a single screen across the first display area 210, the status display area 230, and the second display area 220 of the display unit 130. The method for operating the electronic device 100 may end therewith.

According to an embodiment, if the display unit 130 is closed while a function is being executed, the control unit 170 may output a colored light, which corresponds to the function, in the status display area 230, as illustrated in FIG. 16A. Furthermore, if the display unit 130 is opened, the control unit 170 may display status information through the display unit 130 according to the open angle of the display unit 130, as illustrated in FIGS. 16B-16G. In this regard, the status information may include information related to the function, for example, at least one of identification information and control information. For example, the function may be a music file playing function.

According to another embodiment, if a notification event occurs after the display unit 130 is closed, the control unit 170 may output a colored light, which corresponds to the notification event, in the status display area 230, as illustrated in FIG. 17A. Furthermore, if the display unit 130 is opened, the control unit 170 may display status information through the display unit 130 according to the open angle of the display unit 130, as illustrated in FIGS. 17B-17G. In this regard, the status information may include information related to the notification event, for example, at least one of a notification message, identification information regarding the notification event, and control information regarding the same.

According to another embodiment, the control unit 170 may turn the display unit 130 off, as illustrated in FIG. 18A, when the display unit 130 is closed. Furthermore, if the display unit 130 is opened, the control unit 170 may display status information through the display unit 130 according to the open angle of the display unit 130, as illustrated in FIGS. 18B-18G. In this case, the status information may include at least one status icon that indicates the current status of the electronic device 100.

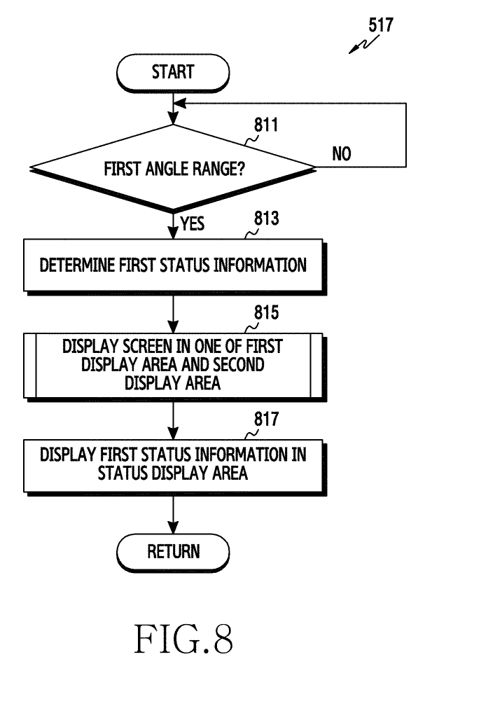

FIG. 8 is a flowchart illustrating a status information displaying operation in connection with FIG. 5, according to an embodiment of the present disclosure.

Referring to FIG. 8, the control unit 170 compares the open angle of the display unit 130 with a first angle range and determines whether the open angle is in the first angle range, in step 811. For example, the first angle range may be greater than 0° and less than or equal to than 90°. If the display unit 130 is opened, as illustrated in FIG. 4B, the open angle of the display unit 130 may be included in the first angle range. In this case, the control unit 170 may operate in a single mode. Furthermore, when it is confirmed that the open angle of the display unit 130 is within the first angle range, the control unit 170 determines first status information, in step 813.

Thereafter, the control unit 170 displays a screen in one of the first display area 210 and the second display area 220, in step 815. In this case, the control unit 170 may turn on one of the first display area 210 and the second display area 220 and display a screen. In this regard, the control unit 170 may display a first screen in the first display area 210 or may display a second screen in the second display area 220. For example, the first screen may be a screen that has been displayed in the first display area 210 before the display unit 130 is closed, and the second screen may be a screen that has been displayed in the second display area 220 before the display unit 130 is closed. To this end, the control unit 170 may supply power to one of the first display area 210 and the second display area 220.

The control unit 170 may drive one of the first display area 210 and the second display area 220 according to a setting that has been made in advance. On the other hand, the control unit 170 may drive one of the first display area 210 and the second display area 220 based on a motion of one of the first display area 210 and the second display area 220. For example, if the second display area 220 is opened from the first display area 210, the control unit 170 may drive the first display area 210. Alternatively, if the first display area 210 is opened from the second display area 220, the control unit 170 may drive the second display area 220.

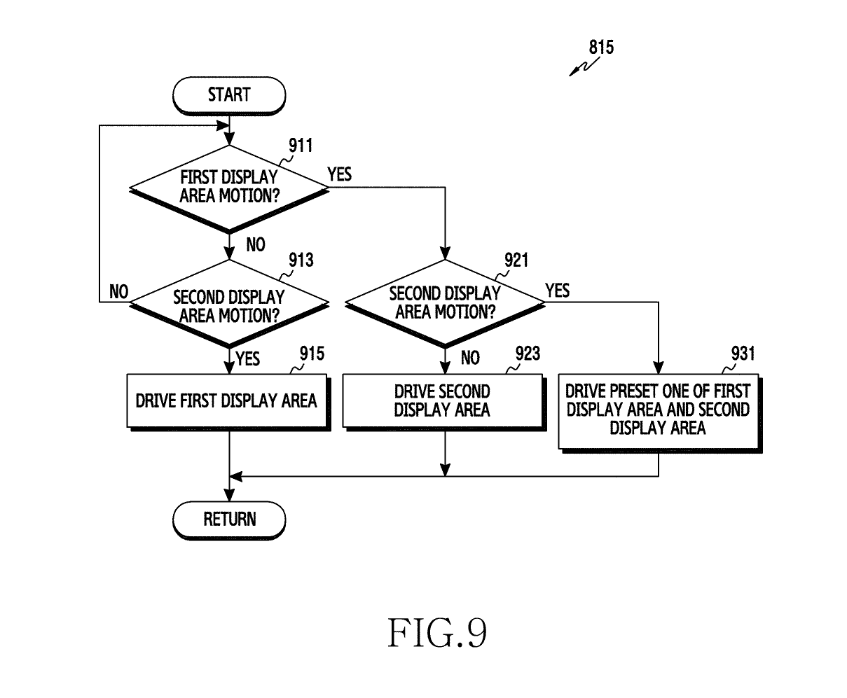

FIG. 9 is a flowchart illustrating an operation for displaying the first display area or the second display area in connection with FIG. 8, according to an embodiment of the present disclosure.

Referring to FIG. 9, the control unit 170 determines whether a motion of the first display area 210 has been sensed, in step 911. Particularly, the control unit 170 may determine whether opening of the display unit 130 has been sensed, based on a motion of the first display area 210.

When no motion of the first display area 210 has been sensed, the control unit 170 determines whether a motion of the second display area 220 has been sensed, in step 913. Particularly, the control unit 170 may determine whether opening of the display unit 130 has been sensed, based on a motion of the second display area 220.

When it is determined that motion of the second display area has not been sensed, the control unit returns to step 911. When it is determined that a motion of the second display area 220 has been sensed, the control unit 170 drives the first display area 210, in step 915. Accordingly, the control unit 170 may display a first screen in the first display area 210. Particularly, if the second display area 220 is opened from the first display area 210, the control unit 170 may display a first screen in the first display area 210. Thereafter, the control unit 170 may return to FIG. 8.

When motion of the first display area 210 has been sensed, the control unit 170 determines whether a motion of the second display area 220 has been sensed, in step 921. Particularly, the control unit 170 may determine whether opening of the display unit 130 has been sensed, based on a motion of the second display area 220.

When it is determined that no motion of the second display area 220 has been sensed, the control unit 170 drives the second display area 220, in step 923. Accordingly, the control unit 170 may display a second screen in the second display area 220. Particularly, if the first display area 210 is opened from the second display area 220, the control unit 170 may display a second screen in the second display area 220. Thereafter, the control unit 170 may return to FIG. 8.

When it is determines that a motion of the second display area 220 has been sensed, the control unit 170 drives a preset one of the first display area 210 and the second display area 220, in step 931. Accordingly, the control unit 170 may display a first screen in the first display area 210 or may display a second screen in the second display area 220. Particularly, if the first display area 210 and the second display area 220 are opened from each other, the control unit 170 may display a first screen in the first display area 210 or may display a second screen in the second display area 220. Thereafter, the control unit 170 may return to FIG. 8.

Referring back to FIG. 8, the control unit 170 displays first status information in the status display area 230, in step 817. In this case, the control unit 170 may turn on the status display area 230 and may display first status information. To this end, the control unit 170 may supply power to the status display area 230. Thereafter, the control unit 170 may return to FIG. 5.

For example, if a music file is being played, the control unit 170 may display music file identification information 1611 as the first status information, as illustrated in FIG. 16B. Alternatively, if a notification event occurs, the control unit 170 may display a notification message 1711 and identification information 1713 regarding the notification event, as illustrated in FIG. 17B. Alternatively, the control unit 170 may magnify at least one predetermined status icon 1811 and display the same as the first status information, as illustrated in FIG. 18B.

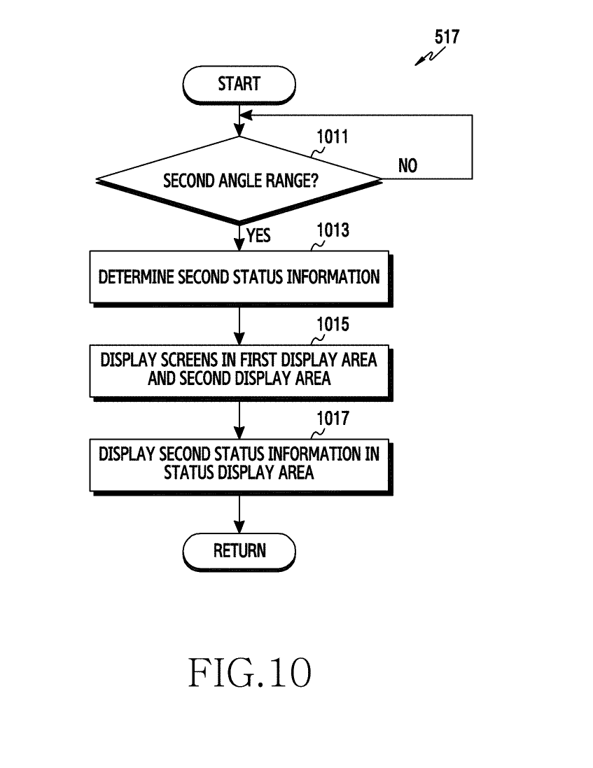

FIG. 10 is a flowchart illustrating a status information displaying operation in connection with FIG. 5, according to an embodiment of the present disclosure.

Referring to FIG. 10, the control unit 170 compares the open angle of the display unit 130 with a second angle range, and determines whether the open angle is within the second angle range, in step 1011. For example, the second angle range may be greater than 90° and less than or equal to than 170°. If the display unit 130 is opened as illustrated in FIG. 4C, the open angle of the display unit 130 may be included in the second angle range. Accordingly, the control unit 170 may operate in a split mode. Furthermore, when it is determined that the open angle of the display unit 130 is within in the second angle range, the control unit 170 determines second status information, in step 1013. In this case, the second status information may be identical to or different from the first status information.

Thereafter, the control unit 170 displays screens in the first display area 210 and the second display area 220, in step 1015. In this case, the control unit 170 may turn on the first display area 210 and the second display area 220 and display screens. In this regard, the control unit 170 may display a first screen in the first display area 210 and may display a second screen in the second display area 220. For example, the first screen may be a screen that has been displayed in the first display area 210 before the display unit 130 is closed, and the second screen may be a screen that has been displayed in the second display area 220 before the display unit 130 is closed. To this end, the control unit 170 may supply power to the first display area 210 and the second display area 220.

Thereafter, the control unit 170 displays second status information in the status display area 230, in operation 1017. In this case, the control unit 170 may turn on the status display area 230 and may display second status information. To this end, the control unit 170 may supply power to the status display area 230. Thereafter, the control unit 170 may return to FIG. 5.

For example, if a music file is being played, the control unit 170 may display music file identification information 1611, information 1613 regarding the folder to which the music file belongs, and a play/pause icon 1615 as the second status information, as illustrated in FIG. 16C. Alternatively, if a notification event occurs, the control unit 170 may display a notification message 1711, identification information 1713 regarding the notification event, and a reply icon 1715 for replying to the notification message as the second status information, as illustrated in FIG. 17C. Alternatively, the control unit 170 may display at least one predetermined status icon 1811 and a call icon 1813 for calling a task menu as the second status information, as illustrated in FIG. 18C.

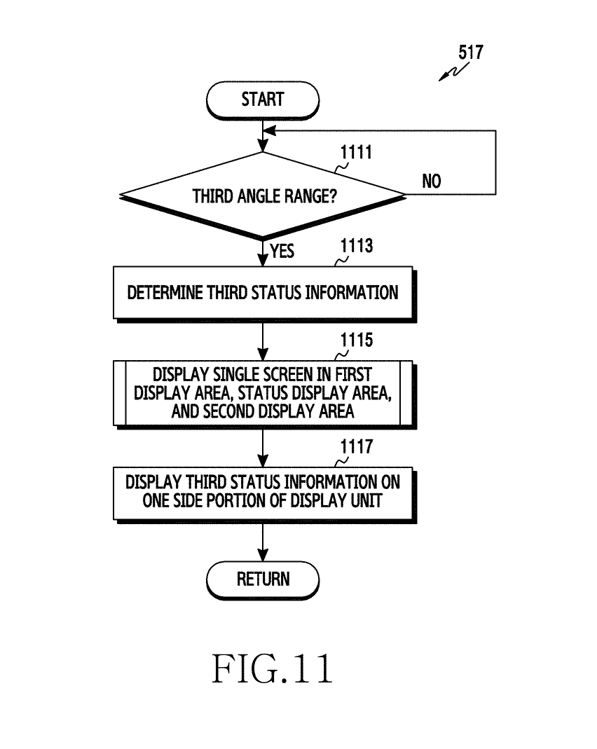

FIG. 11 is a flowchart illustrating a status information displaying operation in connection with FIG. 5, according to an embodiment of the present disclosure.

Referring to FIG. 11, the control unit 170 compares the open angle of the display unit 130 with a third angle range, and determines whether the open angle is within the third angle range, in step 1111. For example, the third angle range may be greater than 170° and less than or equal to 190°. If the display unit 130 is opened as illustrated in FIG. 4D, the open angle of the display unit 130 may be included in the third angle range. Accordingly, the control unit 170 may operate in a full mode. When it is determined that the open angle of the display unit 130 is within in the third angle range, the control unit 170 determines third status information, in step 1113. In this case, the third status information may be identical to at least one of the first status information and the second status information, and may be different from the first status information and the second status information.

Thereafter, the control unit 170 displays screens in the first display area 210, the second display area 220, and the status display area 230, in step 1115. In this case, the control unit 170 may turn on the first display area 210, the second display area 220, and the status display area 230, and may display a single screen as a whole. In this regard, the control unit 170 may display one of a first screen for the first display area 210 and a second screen for the second display area 220 as a single screen. For example, the first screen may be a screen that has been displayed in the first display area 210 before the display unit 130 is closed, and the second screen may be a screen that has been displayed in the second display area 220 before the display unit 130 is closed. To this end, the control unit 170 may supply power to the first display area 210, the second display area 220, and the status display area 230. Furthermore, the control unit 170 may determine a temporary area on one side portion of the display unit 130. Particularly, the control unit 170 may determine a temporary area in one of the first display area 210 and the second display area 220.

The control unit 170 may determine a temporary area in one of the first display area 210 and the second display area 220 according to a setting that has been made in advance. On the other hand, the control unit 170 may determine a temporary area in one of the first display area 210 and the second display area 220 based on a motion of one of the first display area 210 and the second display area 220. For example, if the second display area 220 is opened from the first display area 210, the control unit 170 may determine a temporary area in the first display area 210. Alternatively, if the first display area 210 is opened from the second display area 220, the control unit 170 may determine a temporary area in the second display area 220.

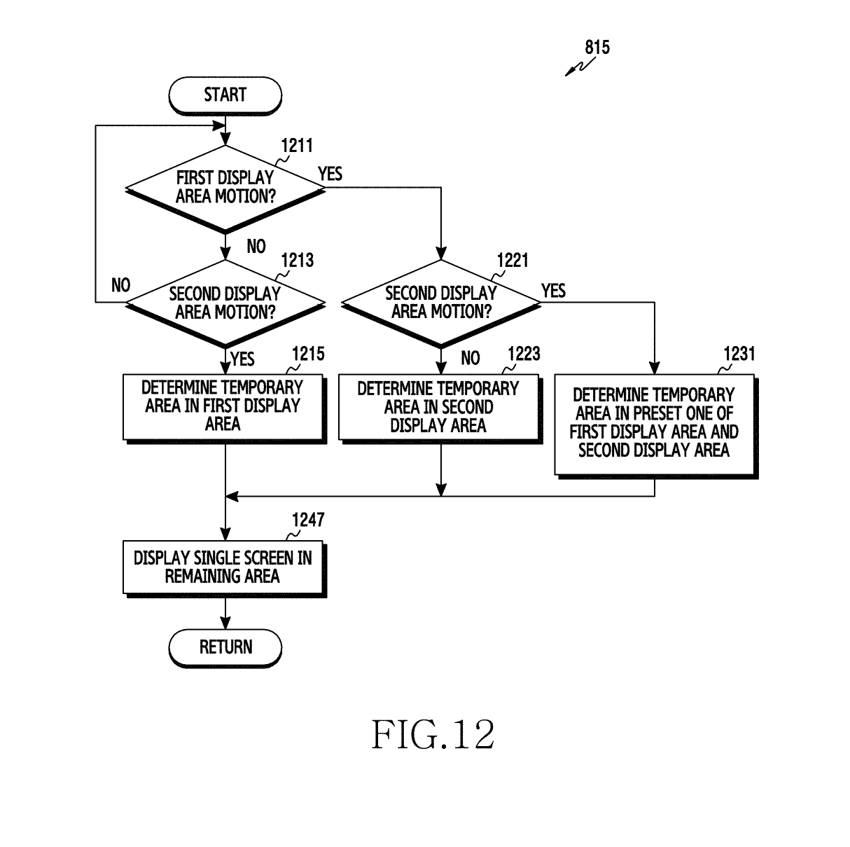

FIG. 12 is a flowchart illustrating an operation for displaying the first display area, the second display area, and the status display area in connection with FIG. 11, according to an embodiment of the present disclosure.

Referring to FIG. 12, the control unit 170 determines whether a motion of the first display area 210 has been sensed, in step 1211. Particularly, the control unit 170 may determine whether opening of the display unit 130 has been sensed, based on the basis of a motion of the first display area 210.

When no motion of the first display area 210 has been sensed, the control unit 170 determines whether a motion of the second display area 220 has been sensed, in step 1213. Particularly, the control unit 170 may determine whether opening of the display unit 130 has been sensed, based on the basis of a motion of the second display area 220.

When it is determined that a motion of the second display area 220 has not been sensed, the control unit 170 returns to step 1211. When it is determined that a motion of the second display area 220 has been sensed, the control unit 170 determines a temporary area in the first display area 210, in step 1215. Particularly, if the second display area 220 is opened from the first display area 210, the control unit 170 may determine a temporary area in the first display area 210. In this case, the control unit 170 may determine a temporary area on one side portion of the first display area 210, i.e. on a side opposite the status display area 230. For example, the size of the temporary area may be identical to the size of the status display area 230.

When it is determined motion of the first display area 210 has been sensed, the control unit 170 determines whether a motion of the second display area 220 has been sensed, in step 1221. Particularly, the control unit 170 may determine whether opening of the display unit 130 has been sensed, based on a motion of the second display area 220.

Thereafter, when it is determined that no motion of the second display area 220 has been sensed, the control unit 170 determines a temporary area in the second display area 220, in step 1223. Particularly, if the first display area 210 is opened from the second display area 220, the control unit 170 may determine a temporary area in the second display area 220. In this case, the control unit 170 may determine a temporary area on one side portion of the second display area 220, i.e. on a side opposite the status display area 230. For example, the size of the temporary area may be identical to the size of the status display area 230.

When it is determined that a motion of the second display area 220 has been sensed, the control unit 170 determines a temporary area in a preset one of the first display area 210 and the second display area 220, in step 1231. Particularly, if the first display area 210 and the second display area 220 are opened from each other, the control unit 170 may determine a temporary area in one of the first display area 210 and the second display area 220. In this case, the control unit 170 may determine a temporary area on one side portion of the first display area 210 or on one side portion of the second display area 220, i.e. on a side opposite the status display area 230.

Thereafter, the control unit 170 displays a single screen in the remaining area of the display unit 130, in step 1247. Particularly, the control unit 170 may display a single screen in the remaining area of the display unit 130, other than the temporary area, as a whole. In this regard, the control unit 170 may display one of a first screen for the first display area 210 and a second screen for the second display area 220 as a single screen. To this end, the control unit 170 may supply power to the first display area 210, the second display area 220, and the status display area 230. The control unit 170 may return to FIG. 11.

Referring back to FIG. 11, the control unit 170 displays third status information on one side portion of the display unit 130, in step 1117. In this case, the control unit 170 may display the third status information in one of the first display area 210 and the second display area 220. Particularly, the control unit 170 may display the third status information in a temporary area of the display unit 130. Thereafter, the control unit 170 may return to FIG. 5.

For example, if a music file is being played, the control unit 170 may display music file identification information 1611, information 1613 regarding the folder to which the music file belongs, a play/pause icon 1615, and a music file seek bar 1617 as the third status information, as illustrated in FIG. 16D or FIG. 16E. Alternatively, if a notification event occurs, the control unit 170 may display a notification message 1711, identification information 1713 regarding the notification event, and a reply icon 1715 for replying to the notification message 1711 as the third status information, as illustrated in FIG. 17D or FIG. 17E. In addition thereto, the control unit 170 may additionally display a message composition window 1717 for replying to the notification message 1711 in at least one of the first display area 210, the second display area 220, and the status display area 230. Alternatively, the control unit 170 may display at least one predetermined status icon 1811 as the third status information, as illustrated in FIG. 18D or FIG. 18E.

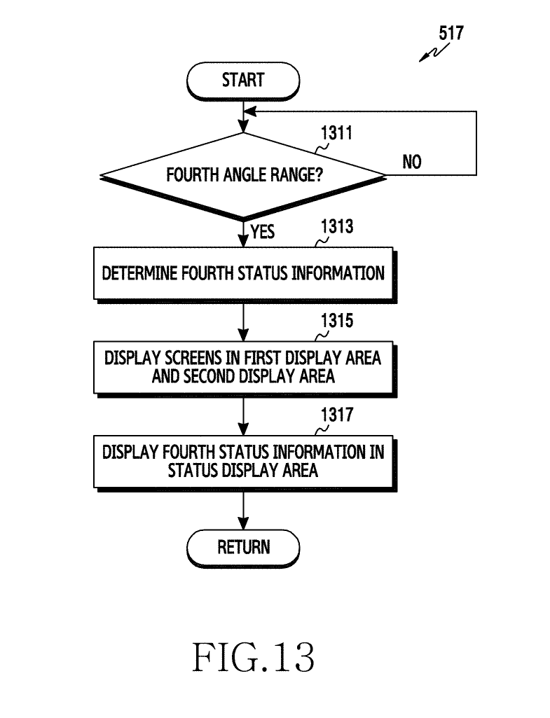

FIG. 13 is a flowchart illustrating a status information displaying operation in connection with FIG. 5, according to an embodiment of the present disclosure.

Referring to FIG. 13, the control unit 170 compares the open angle of the display unit 130 with a fourth angle range, and determines whether the open angle is within the fourth angle range, in step 1311. For example, the fourth angle range may be greater than 190° and less than or equal to 330°. If the display unit 130 is opened, as illustrated in FIG. 4E, the open angle of the display unit 130 may be included in the fourth angle range. Accordingly, the control unit 170 may operate in a cradling mode. When the open angle of the display unit 130 is within the fourth angle range, the control unit 170 determines fourth status information, in step 1313. In this case, the fourth status information may be identical to at least one of the first status information, the second status information, and the third status information, and may be different from the first status information, the second status information, and the third status information.

The control unit 170 displays screens in the first display area 210 and the second display area 220, in step 1315. In this case, the control unit 170 may turn on the first display area 210 and the second display area 220 and display screens. In this regard, the control unit 170 may display a first screen in the first display area 210 and may display a second screen in the second display area 220. For example, the first screen may be a screen that has been displayed in the first display area 210 before the display unit 130 is closed, and the second screen may be a screen that has been displayed in the second display area 220 before the display unit 130 is closed. To this end, the control unit 170 may supply power to the first display area 210 and the second display area 220. In addition, the control unit 170 may rotate the first screen and the second screen such that the upper end portion of the first screen and the upper end portion of the second screen face the status display area 230.

The control unit 170 displays fourth status information in the status display area 230, in step 1317. In this case, the control unit 170 may turn on the status display area 230 and may display fourth status information. To this end, the control unit 170 may supply power to the status display area 230. Thereafter, the control unit 170 may return to FIG. 5.

For example, if a music file is being played, the control unit 170 may display music file identification information 1611, information 1613 regarding the folder to which the music file belongs, a play/pause icon 1615, a music file seek bar 1617, a fast backward/forward icon 1619, and a volume adjustment icon 1621 as the fourth status information, as illustrated in FIG. 16F. Alternatively, if a notification event occurs, the control unit 170 may display a notification message 1711, identification information 1713 regarding the notification event, a reply icon 1715 for replying to the notification message 1711, and a recording icon 1719 for voice recording as the fourth status information, as illustrated in FIG. 17F. Alternatively, the control unit 170 may display at least one predetermined status icon 1811, a call icon 1813 for calling a task menu, and a voice recording icon 1815 for voice recording as the fourth status information, as illustrated in FIG. 18F.

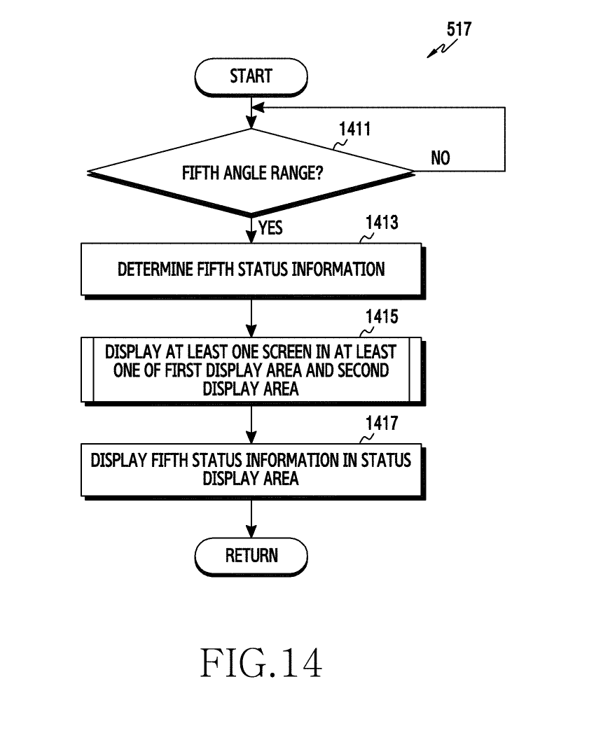

FIG. 14 is a flowchart illustrating a status information displaying operation in connection with FIG. 5, according to an embodiment of the present disclosure.

Referring to FIG. 14, the control unit 170 compares the open angle of the display unit 130 with a fifth angle range, and determines whether the open angle is within the fifth angle range, in step 1411. For example, the fifth angle range may be greater than 330° and less than or equal to 360°. If the display unit 130 is opened, as illustrated in FIG. 4F, the open angle of the display unit 130 may be included in the fifth angle range. Accordingly, the control unit 170 may operate in a phone mode. Furthermore, when it is determined that the open angle of the display unit 130 is included in the fifth angle range, the control unit 170 determines fifth status information, in step 1413. In this case, the fifth status information may be identical to at least one of the first status information, the second status information, the third status information, and the fourth status information, and may be different from the first status information, the second status information, the third status information, and the fourth status information.

Thereafter, the control unit 170 displays at least one screen in at least one of the first display area 210 and the second display area 220, in step 1415. In this case, the control unit 170 may turn on at least one of the first display area 210 and the second display area 220, and display at least one screen. In this regard, the control unit 170 may display a first screen in the first display area 210 or may display a second screen in the second display area 220. Alternatively, the control unit 170 may display a first screen in the first display area 210 and may display a second screen in the second display area 220. For example, the first screen may be a screen that has been displayed in the first display area 210 before the display unit 130 is closed, and the second screen may be a screen that has been displayed in the second display area 220 before the display unit 130 is closed. To this end, the control unit 170 may supply power to at least one of the first display area 210 and the second display area 220.

The control unit 170 may drive at least one of the first display area 210 and the second display area 220 according to a setting that has been made in advance. On the other hand, the control unit 170 may drive at least one of the first display area 210 and the second display area 220 based on a motion of at least one of the first display area 210 and the second display area 220. For example, if the second display area 220 is opened from the first display area 210, the control unit 170 may drive the first display area 210. Alternatively, if the first display area 210 is opened from the second display area 220, the control unit 170 may drive the second display area 220. The operation for displaying at least one of the first display area 210 and the second display area 220 may be similar to that illustrated in FIG. 9.

Thereafter, the control unit 170 displays fifth status information in the status display area 230, in step 1417. In this case, the control unit 170 may turn on the status display area 230 and may display fifth status information. To this end, the control unit 170 may supply power to the status display area 230. Thereafter, the control unit 170 may return to FIG. 5.

For example, if a music file is being played, the control unit 170 may display music file identification information 1611, information 1613 regarding the folder to which the music file belongs, and a play/pause icon 1615 as the fifth status information, as illustrated in FIG. 16G. Alternatively, if a notification event occurs, the control unit 170 may display a notification message 1711, identification information 1713 regarding the notification event, and a reply icon 1715 for replying to the notification message as the fifth status information, as illustrated in FIG. 17G. In addition thereto, the control unit 170 may additionally display a message composition window 1717 for replying to the notification message 1711 in at least one of the first display area 210, the second display area 220, and the status display area 230. Alternatively, the control unit 170 may display at least one predetermined status icon 1811 as the fifth status information, as illustrated in FIG. 18G.

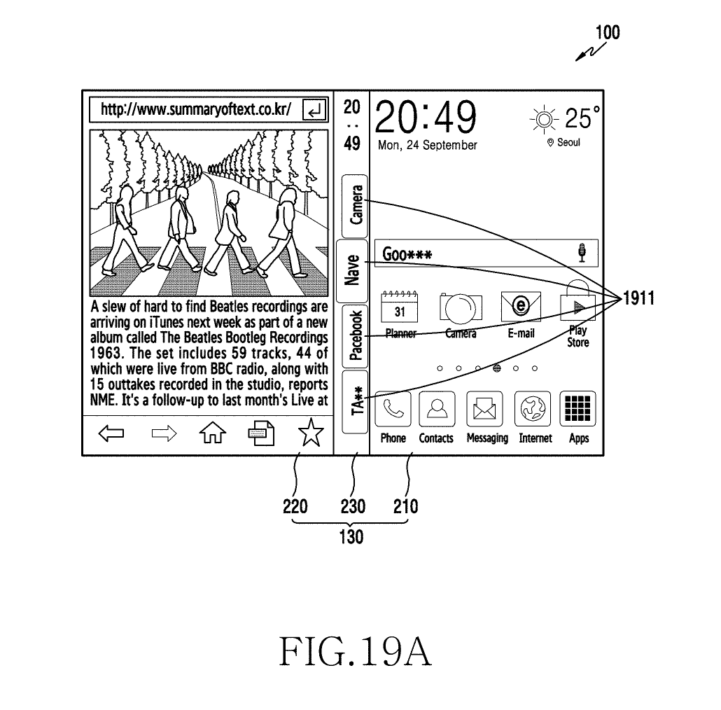

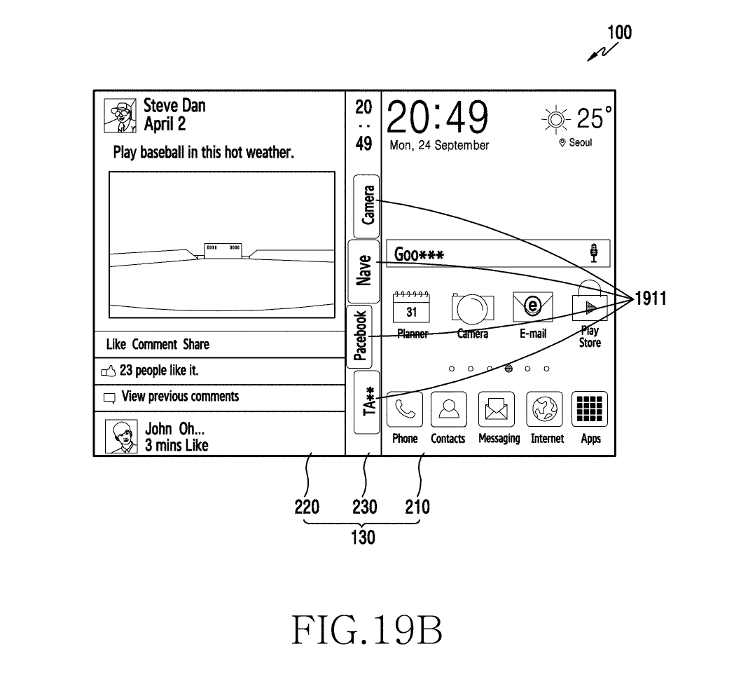

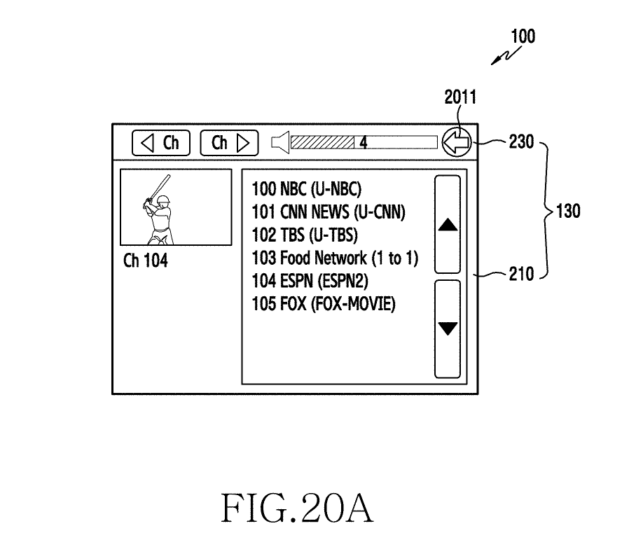

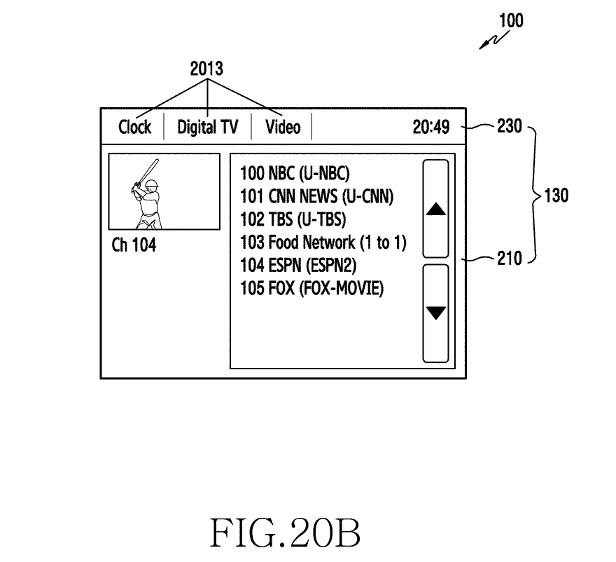

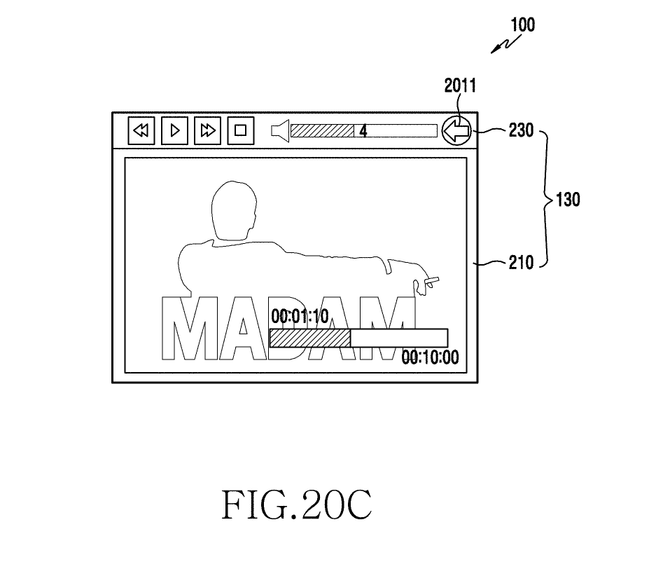

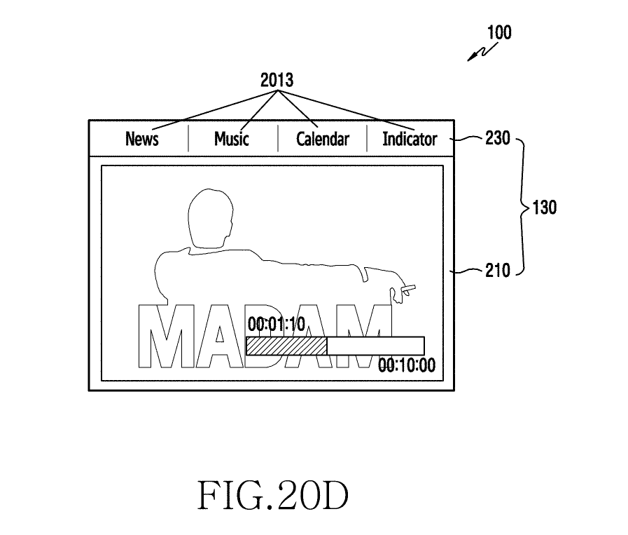

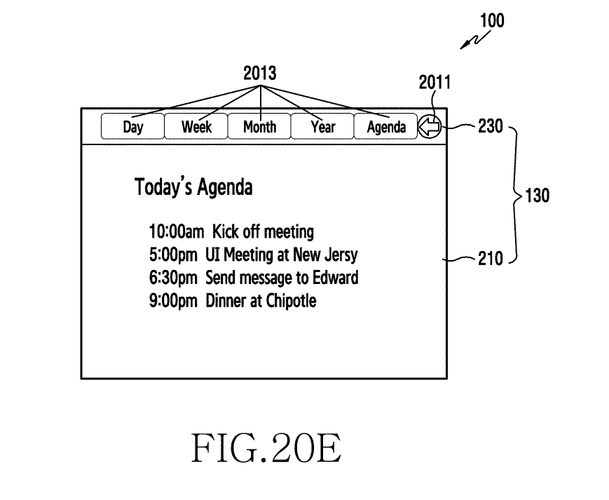

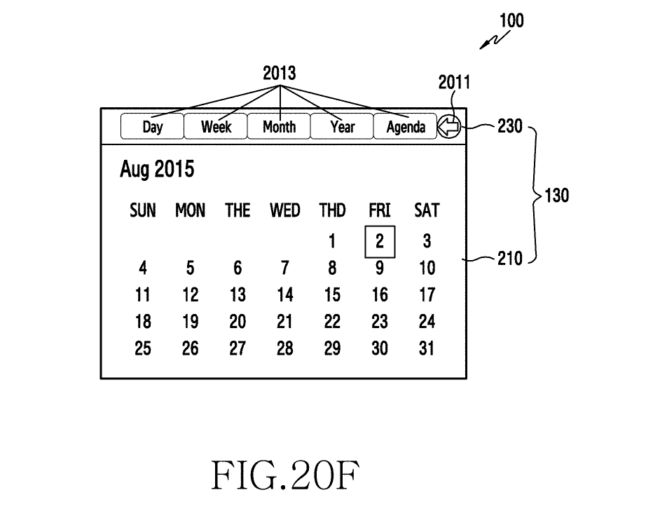

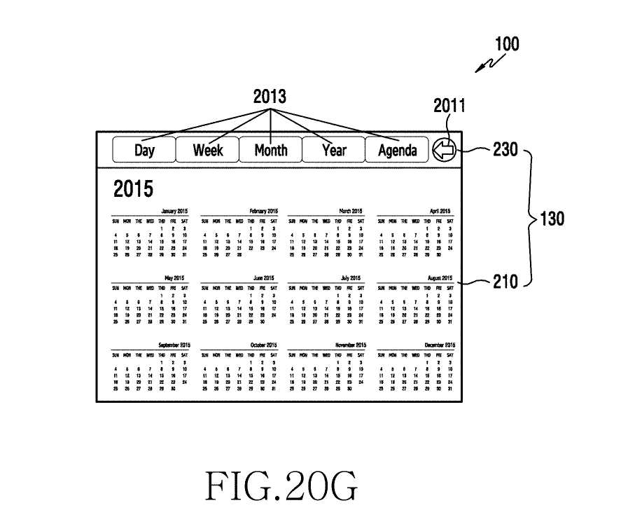

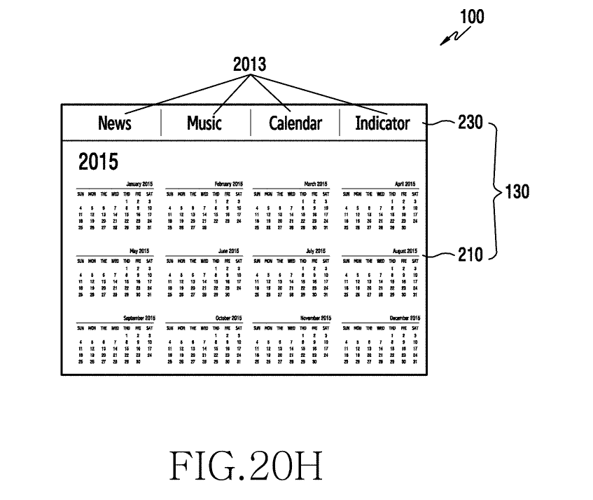

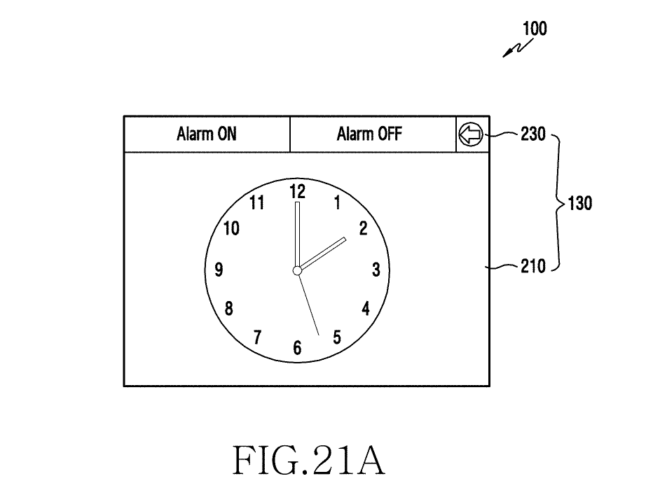

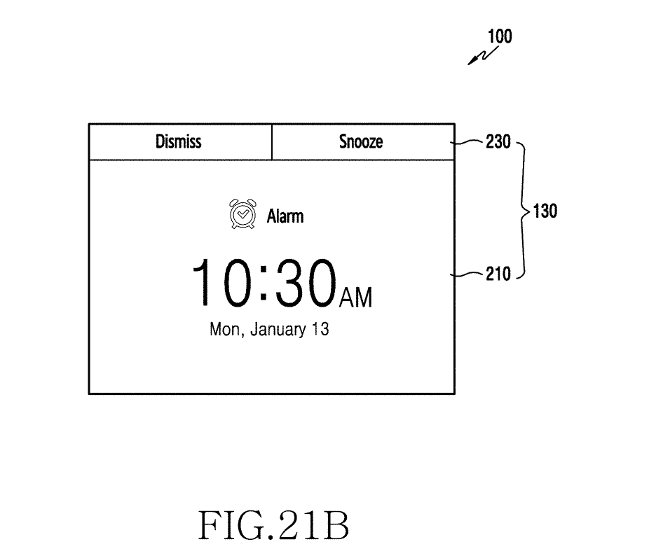

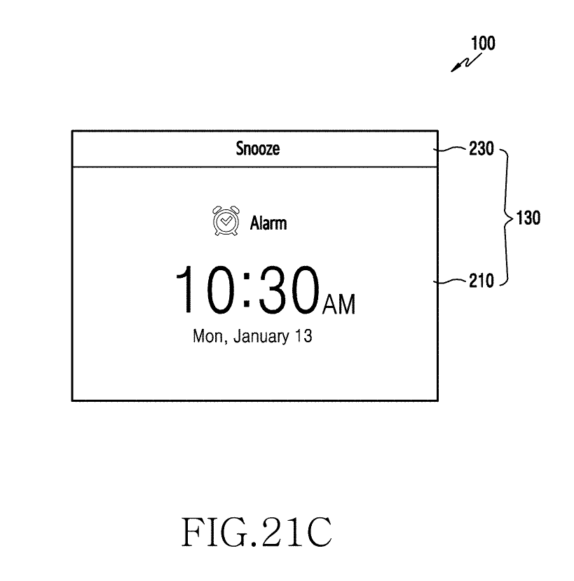

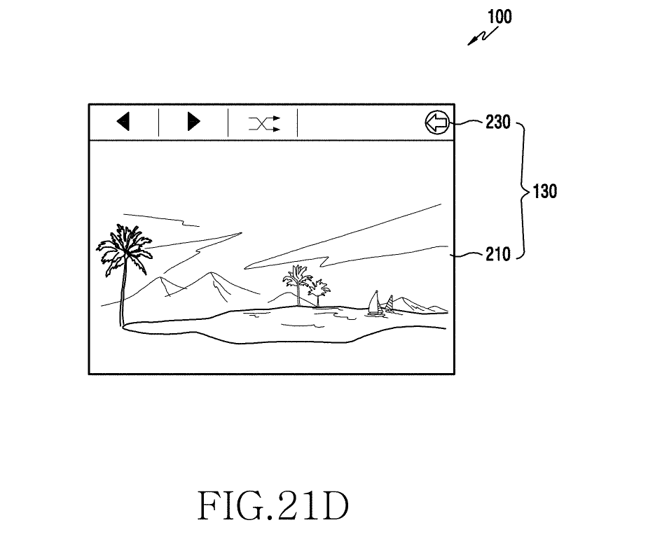

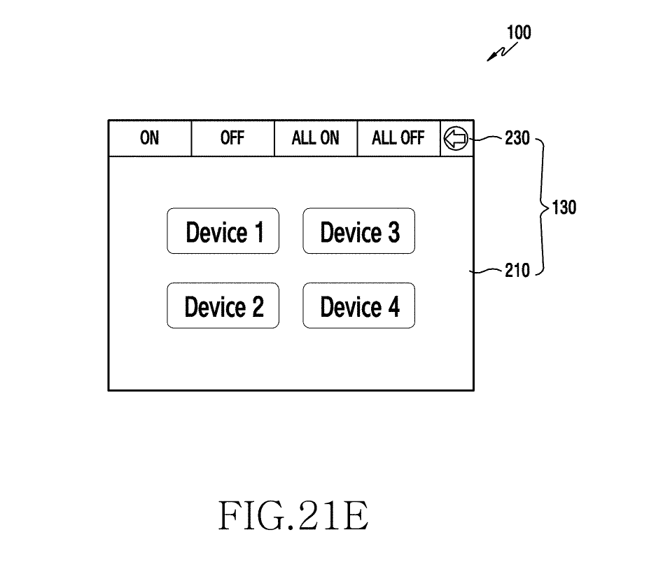

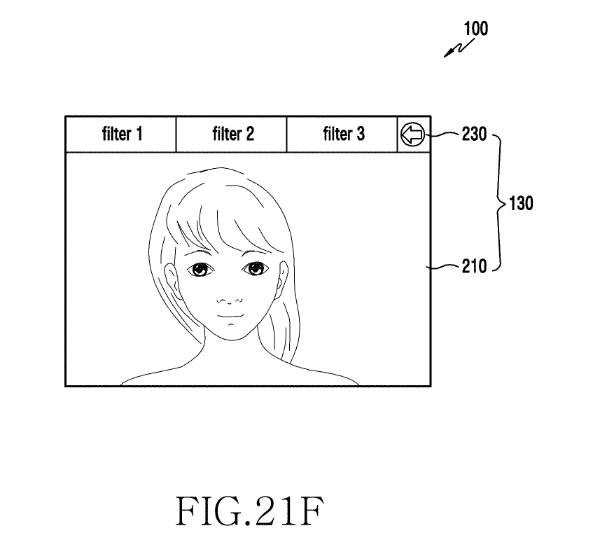

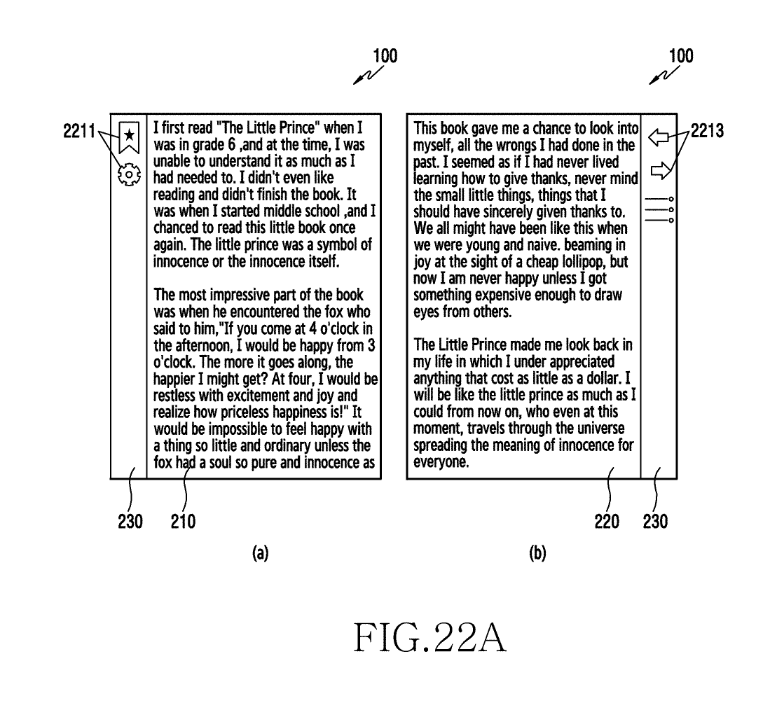

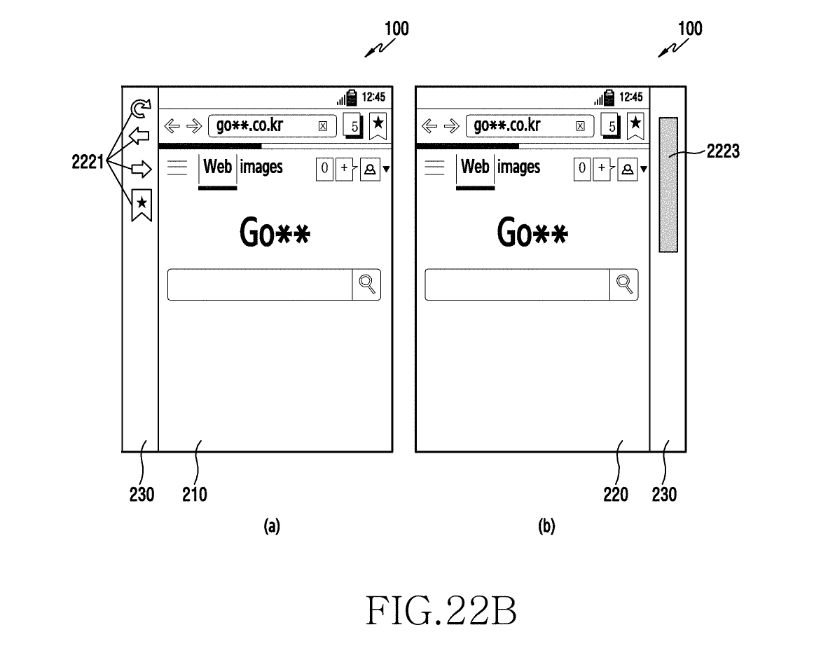

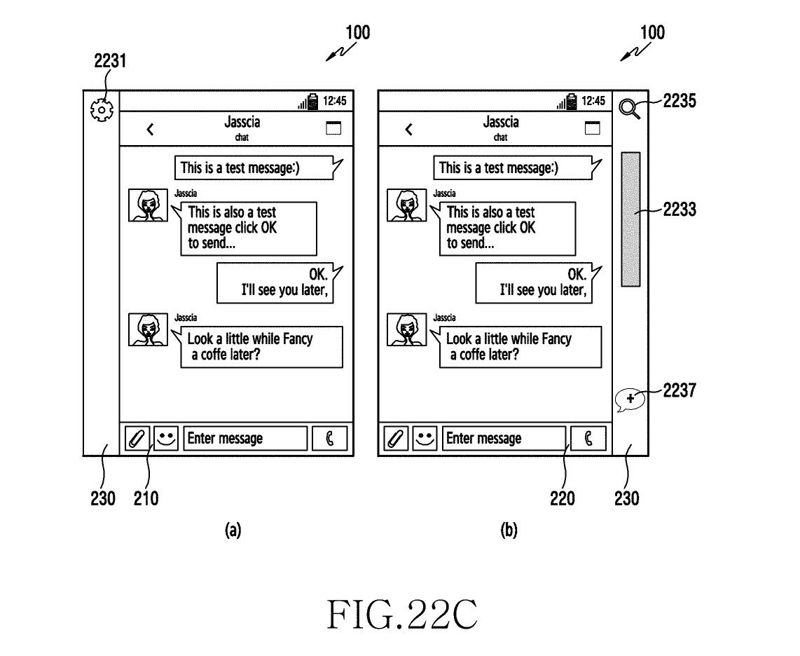

FIGS. 19A and 19B are diagrams illustrating an electronic device operating method, according to embodiments of the present disclosure. FIGS. 20A-20H are diagrams illustrating an electronic device operating method, according to embodiments of the present disclosure. FIGS. 21A-21F are diagrams illustrating an electronic device operating method, according to an embodiment of the present disclosure. FIGS. 22A-22C are diagrams illustrating an electronic device operating method, according to an embodiment of the present disclosure.

According to an embodiment of the present disclosure, the control unit 170 may display at least one preset task menu 1911 in the status display area 230. For example, the control unit 170 calls task menus 1911 and displays the same in the status display area 230, as illustrated in FIG. 19A. In this case, each task menu 1911 may correspond to a preset function. In addition, when a task menu 1911 is selected in the status display area 230, the control unit 170 may execute a function corresponding to the task menu 1911. In this case, the control unit 170 displays a function execution screen in one of the first display area 210 and the second display area 220, as illustrated in FIG. 19B. For example, when a swipe from a task menu 1911 in the status display area 230 to the first display area 210 is sensed, the control unit 170 may display an execution screen in the first display area 210. Alternatively, when a swipe from a task menu 1911 in the status display area 230 to the second display area 220 is sensed, the control unit 170 may display an execution screen in the second display area 220.

The electronic device 100 may be cradled according to the open angle of the display unit 130. When the open angle of the display unit 130 is within the fourth angle range, the electronic device 100 may be cradled on the ground through both ends thereof. Accordingly, the display unit 130, particularly, all of the first display area 210, the second display area 220, and the status display area 230 may be exposed to the outside.

According to an embodiment of the present disclosure, the control unit 170 may display screens for executing various functions in the first display area 210 and the second display area 220. In addition, the control unit 170 may display at least one preset task menu 1911 in the status display area 230. To this end, the control unit 170 may display a call icon 2011 in the status display area 230.

For example, the control unit 170 reproduces a digital broadcast through at least one of the first display area 210 and the second display area 220, as illustrated in FIG. 20A. In this case, the control unit 170 displays a call icon 2011 in the status display area 230. If the call icon 2011 is selected in the status display area 230, the control unit 170 displays task menus 2013 in the status display area 230, as illustrated in FIG. 20B. If a task menu 2013, for example, the video function is selected in the status display area 230, the control unit 170 plays a video file through at least one of the first display area 210 and the second display area 220, as illustrated in FIG. 20C. In this case, the control unit 170 may display a call icon 2011 in the status display area 230. If the call icon 2011 is selected in the status display area 230, the control unit 170 displays task menus 2013 in the status display area 230, as illustrated in FIG. 20D. If a task menu 2013, for example, the schedule function is selected in the status display area 230, the control unit 170 displays the schedule through at least one of the first display area 210 and the second display area 220, as illustrated in FIGS. 20E-20G. Particularly, the control unit 170 may display the schedule for each day or may display the schedule together with the calendar for each month or year. In this case, the control unit 170 may display a call icon 2011 in the status display area 230. If the call icon 2011 is selected in the status display area 230, the control unit 170 displays task menus 2013 in the status display area 230, as illustrated in FIG. 20H.

According to another embodiment, the control unit 170 may display screens for executing various functions in the first display area 210 and the second display area 220. In addition, the control unit 170 may display control icons for controlling functions in the status display area 230.

For example, the control unit 170 displays a clock in at least one of the first display area 210 and the second display area 220, as illustrated in FIGS. 21A-21C. In addition, the control unit 170 may display an alarm icon for turning on or off the alarm function in the status display area 230. Furthermore, when the alarm time arrives, the control unit 170 may display at least one of a release icon for releasing the alarm and a snooze icon for temporarily stopping the alarm in the status display area 230. In this case, when a touch gesture is sensed in response to the clock in at least one of the first display area 210 and the second display area 220, the control unit 170 may set the alarm time. Accordingly, the electronic device 100 may play the role of a table clock.

Alternatively, the control unit 170 displays a preset image in at least one of the first display area 210 and the second display area 220, as illustrated in FIG. 21D. In addition, the control unit 170 may display a switching icon for displaying another image in the status display area 230. Accordingly, the electronic device 100 may play the role of a picture frame.

Alternatively, the control unit 170 displays items, which indicate preset external devices, in at least one of the first display area 210 and the second display area 220, as illustrated in FIG. 21E. In addition, the control unit 170 may display remote control items for remotely controlling the external devices in the status display area 230. Accordingly, the electronic device 100 may play the role of a remote controller.

Alternatively, the control unit 170 displays an image, which is taken by the camera unit 140, in at least one of the first display area 210 and the second display area 220, as illustrated in FIG. 21F. In addition, the control unit 170 may display effect icons for applying effects to the image in the status display area 230. Accordingly, the electronic device 100 may play the role of a mirror.

The sensor unit 170 may determine status information on the basis of a motion of the display unit 130. In this case, when the open angle of the display unit 130 is included in the fifth angle range, the direction of the status display area 230 may be changed according to the arrangement of the first display area 210 and the second display area 220. One of the first display area 210 and the second display area 220 may face the user of the electronic device 100. For example, when the first display area 210 faces the user of the electronic device 100, the status display area 230 may be directed towards the left side of the user of the electronic device 100. On the other hand, when the second display area 220 faces the user of the electronic device 100, the status display area 230 may be directed towards the right side of the user of the electronic device 100. Accordingly, the control unit 170 may determine status information based on the direction of the status display area 230.

For example, the control unit 170 displays an electronic document in the first display area 210 or the second display area 220, as illustrated in FIG. 22A. In such a case, if the direction of the status display area 230 is determined as illustrated in (a) of FIG. 22A, the control unit 170 displays setting icons 2211 in the status display area 230. Alternatively, if the direction of the status display area 230 is determined as illustrated in (b) of FIG. 22A, the control unit 170 displays page control icons 2213 in the status display area 230. On the other hand, the control unit 170 displays a web page in the first display area 210 or the second display area 220, as illustrated in FIG. 22B. In such a case, if the direction of the status display area 230 is determined as illustrated in (a) of FIG. 22B, the control unit 170 displays page control icons 2221 in the status display area 230. Alternatively, if the direction of the status display area 230 is determined as illustrated in (b) of FIG. 22B, the control unit 170 displays a scroll bar 2223 in the status display area 230. On the other hand, the control unit 170 displays a message exchange screen in the first display area 210 or the second display area 220, as illustrated in FIG. 22C. In such a case, if the direction of the status display area 230 is determined as illustrated in (a) of FIG. 22C, the control unit 170 displays a setting icon 2231 in the status display area 230. Alternatively, if the direction of the status display area 230 is determined as illustrated in (b) of FIG. 22C, the control unit 170 displays a scroll bar 2233, a search icon 2235, and an addition icon 2237 for adding a dialogue partner in the status display area 230.

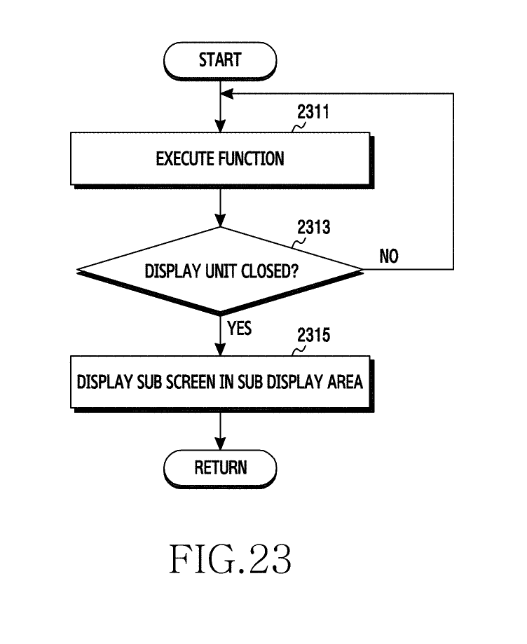

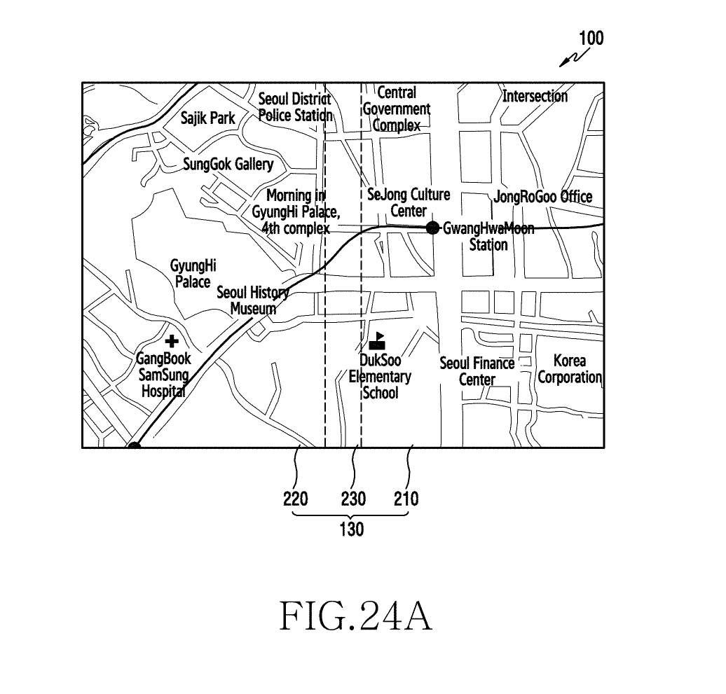

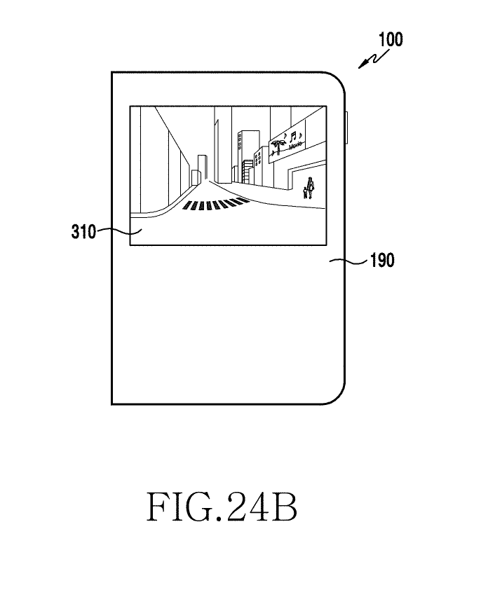

FIG. 23 is a flowchart illustrating an electronic device operating method, according to an embodiment of the present disclosure. FIG. 24A and FIG. 24B are diagrams illustrating an electronic device operating method, according to an embodiment of the present disclosure.

Referring to FIG. 23, a function is executed by the control unit 170, in step 2311. In this case, if the display unit 130 is opened as illustrated in one of FIGS. 4B-4F, the control unit 170 may display at least one function execution screen through the display unit 130. For example, the function may be a map search function, and the control unit 170 displays a map screen through at least one of the first display area 210, the status display area 230, and the second display area 220, as illustrated in FIG. 24A. The control unit 170 then may set a destination on the map screen on the basis of the user's request.

In step 2313, the control unit 170 determines whether the display unit is closed. In this case, the control unit 170 may sense a motion of the display unit 130 through a sensor unit 150. When the display unit 130 is closed, as illustrated in FIG. 4A, the control unit 170 may sense the same. For example, the control unit 170 may sense a motion of at least one of the first display area 210 and the second display area 220 through the sensor unit 150. Furthermore, the control unit 170 may detect the angle between the first display area 210 and the second display area 220 on the basis of a motion of at least one of the first display area 210 and the second display area 220. In this regard, the control unit 170 may determine, when the angle between the first display area 210 and the second display area 220 is less than or equal to 0°, that the display unit 130 is closed.

When it is determined that the display unit 130 is not closed, the control unit returns to step 2311. When it is determined that the display unit 130 is closed, the control unit 170 displays a sub screen in the sub display area 310, in step 2315. In this case, the control unit 170 may display a screen for executing another preset function as the sub screen, so as correspond to the currently executed function. For example, if the display unit 130 is closed while the map search function is being executed, the control unit 170 may execute a navigation function. Furthermore, the control unit 170 displays a navigation screen in the sub display area 310, as illustrated in FIG. 24B.

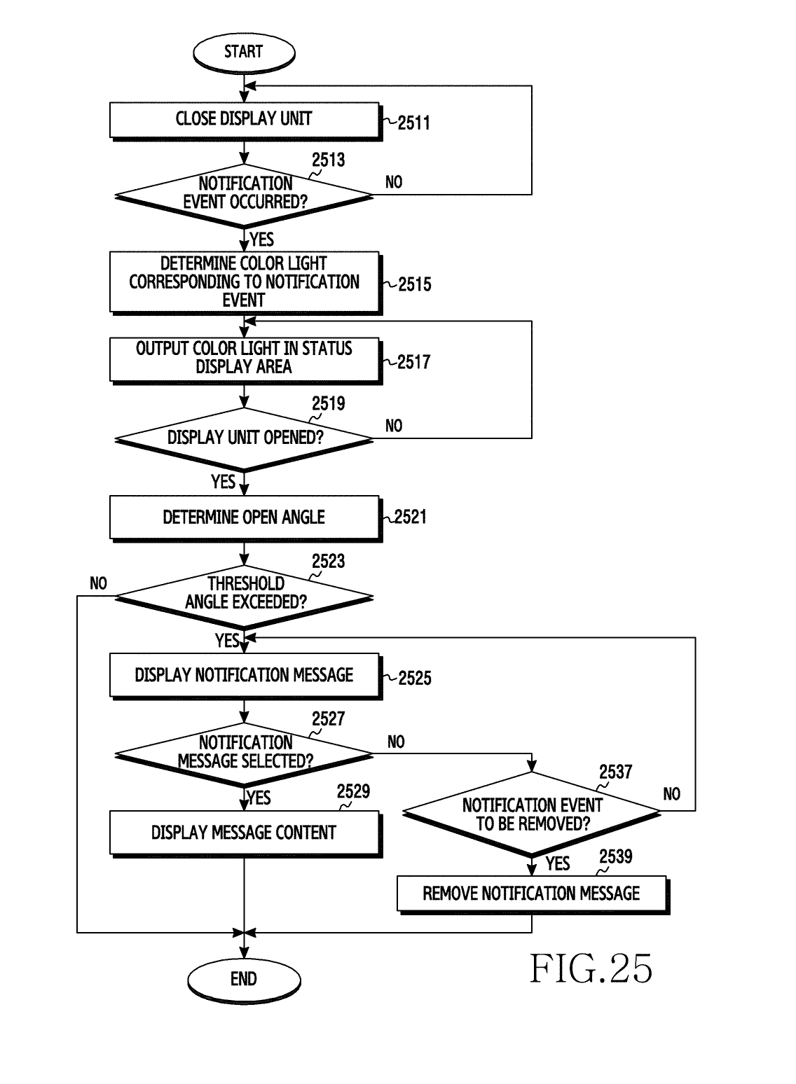

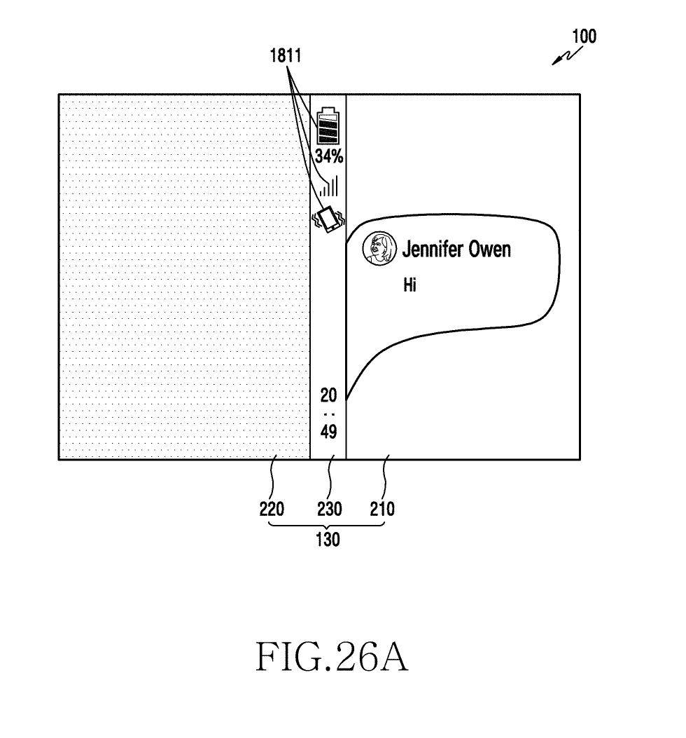

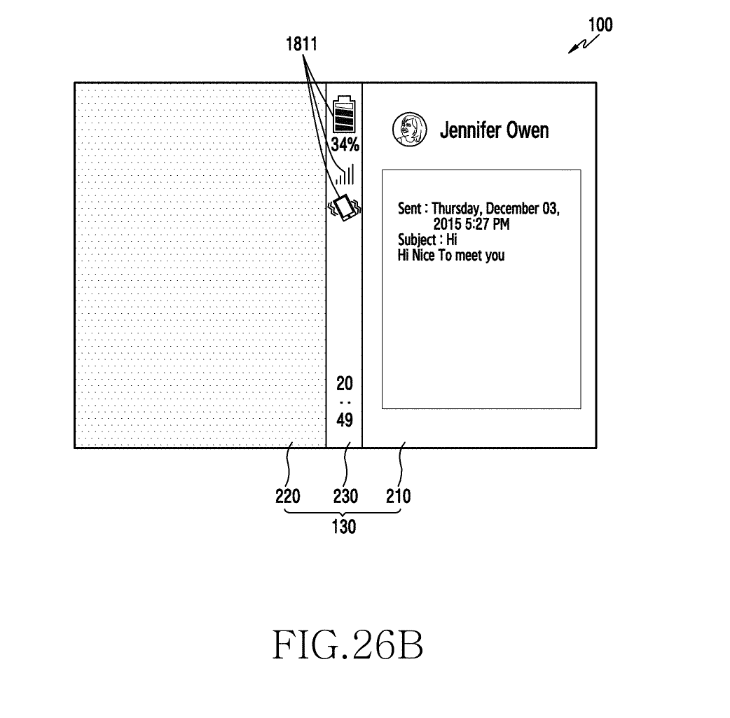

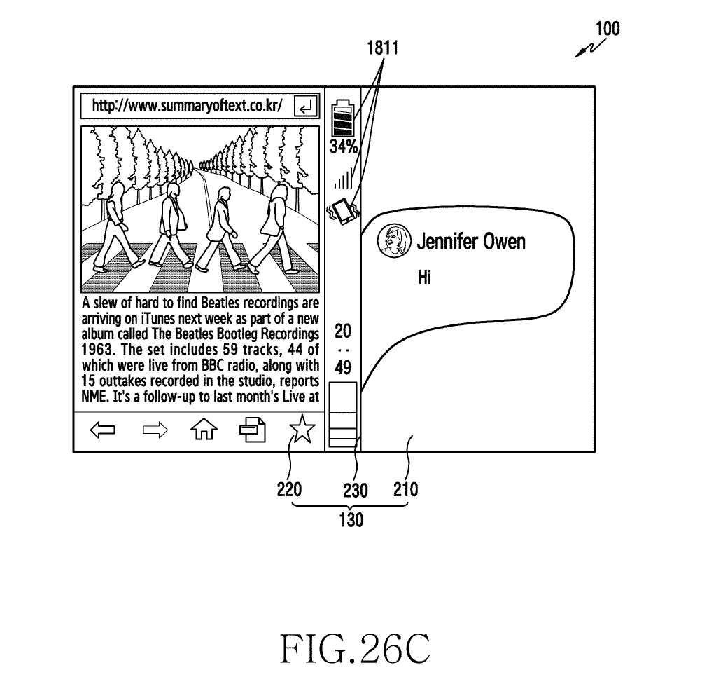

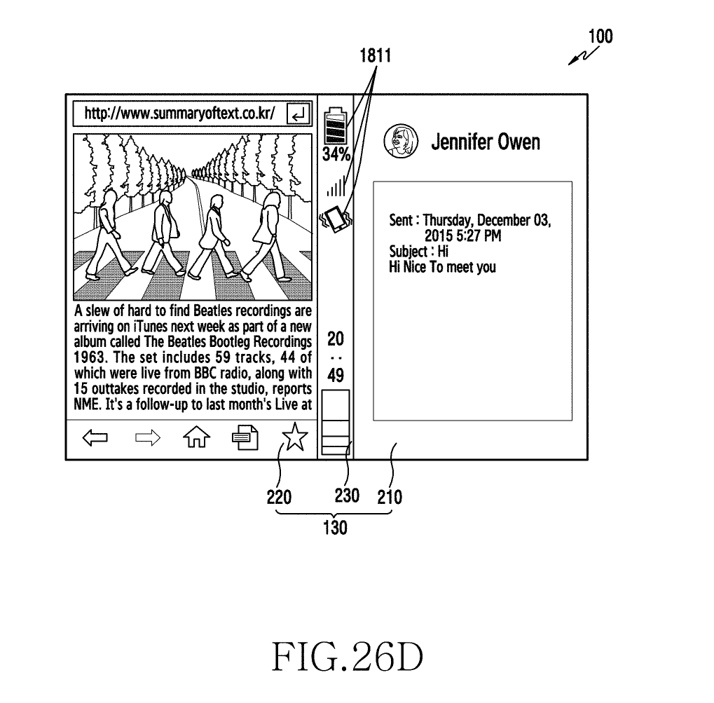

FIG. 25 is a flowchart illustrating an electronic device operating method, according to an embodiment of the present disclosure. FIGS. 26A-26D are diagrams illustrating an electronic device operating method, according to an embodiment of the present disclosure.

Referring to FIG. 25, the control unit senses the closing of the display unit 130, in step 2511. In this case, the control unit 170 may sense a motion of the display unit 130 through a sensor unit 150. When the display unit 130 is closed, as illustrated in FIG. 4A, the control unit 170 may sense the same. For example, the control unit 170 may sense a motion of at least one of the first display area 210 and the second display area 220 through the sensor unit 150. Furthermore, the control unit 170 may detect the angle between the first display area 210 and the second display area 220 based on a motion of at least one of the first display area 210 and the second display area 220. In this regard, the control unit 170 may determine, when the angle between the first display area 210 and the second display area 220 is less than or equal to 0°, that the display unit 130 is closed.

According to an embodiment of the present disclosure, the control unit 170 may turn the display unit 130 off when the display unit 130 is closed. In this case, the control unit 170 may turn off the first display area 210, the second display area 220, and the status display area 230. Particularly, the control unit 170 may block power supply to the first display area 210, the second display area 220, and the status display area 230. Alternatively, the control unit 170 may turn off the first display area 210 and the second display area 220 and may turn on the status display area 230. Particularly, the control unit 170 may block power supply to the first display area 210 and the second display area 220 and may supply power to the status display area 230. For example, when the display unit 130 is closed while a function is being executed, the control unit 170 may turn off the first display area 210 and the second display area 220 and may turn on the status display area 230.

The control unit 170 determines whether a notification event occurred, in step 2513. In this case, the notification event may include a communication event and a schedule event. For example, the communication event may occur in response to reception of a call, a message, or power. The schedule event may occur in response to arrival of a schedule or an alarm time.

When it is determined that the notification event has not occurred, the control unit 170 returns to step 2511. When it is determined that the notification event has occurred, the control unit 170 determines a color of the light, which corresponds to the notification event, in step 2515. In this case, the control unit 170 may determine at least one of the color of the light, the output time interval, the output intensity, and the output type, according to the notification event. The control unit 170 outputs the colored light in the status display area 230 of the display unit 130, in step 2517. In this case, when the status display area 230 is opened, the control unit 170 may turn on the status display area 230 and output the colored light. For example, the control unit 170 may output a yellow light in the status display area 230 in response to originator A. Alternatively, the control unit 170 may output a blue light in the status display area 230 in response to originator B. Alternatively, when a call is received, the control unit 170 may output a green light in the status display area 230. Alternatively, when power is received, the control unit 170 may output a red light in the status display area 230.

The control unit 170 determines whether the display unit 130 is opened, in step 2519. In this case, the control unit 170 may sense a motion of the display unit 130 through a sensor unit 150. For example, the control unit 170 may sense a motion of at least one of the first display area 210 and the second display area 220.

When it is determined that the display unit 130 is not opened, the control unit 170 returns to step 2517. When it is determined that the display unit 130 is opened, the control unit 170 detects the open angle of the display unit 130, in step 2521. In this case, if the motion of the display unit 130 stops, the control unit 170 may detect the open angle of the display unit 130. As the display unit 130 is opened, as illustrated in one of FIGS. 4B-4F, the control unit 170 may detect the open angle of the display unit 130. For example, the control unit 170 may detect the angle between the first display area 210 and the second display area 220, i.e., open angle, based on a motion of at least one of the first display area 210 and the second display area 220. For example, the open angle may be determined in such a range that the same exceeds 0° and is less than or equal to 360°.

Subsequently, the control unit 170 compares the open angle of the display unit 130 with a preset threshold angle, and determines whether the open angle is greater than the preset threshold angle, in step 2523. For example, the threshold angle may be 0°.

If the open angle of the display unit 130 is greater than the threshold angle, the control unit 170 displays a notification message through the display unit 130, in step 2525. In this case, the control unit 170 may turn on one of the first display area 210 and the second display area 220. In addition, the control unit 170 may display a notification message in one of the first display area 210 and the second display area 220. For example, the control unit 170 may turn on the first display area 210 and may display a notification message in the first display area 210, as illustrated in FIG. 26A. Alternatively, the control unit 170 may turn on the first display area 210 and the second display area 220 and may display a notification message in the first display area 210, as illustrated in FIG. 26C.

According to an embodiment of the present disclosure, the control unit 170 may drive at least one of the first display area 210 and the second display area 220 based on the open angle of the display unit 130. In this case, if the open angle of the display unit 130 is within the first angle range, the control unit 170 may turn on one of the first display area 210 and the second display area 220 and may display a notification message. On the other hand, if the open angle of the display unit 130 is within one of the second angle range, the third angle range, and the fourth angle range, the control unit 170 may turn on the first display area 210 and the second display area 220 and may display a notification message in one of the first display area 210 and the second display area 220. On the other hand, if the open angle of the display unit 130 is within the fifth angle range, the control unit 170 may turn on one of the first display area 210 and the second display area 220 and may display a notification message in one of the first display area 210 and the second display area 220.

The control unit 170 may display a notification message in one of the first display area 210 and the second display area 220 based on the open angle of the display unit 130. The control unit 170 may display a notification message in one of the first display area 210 and the second display area 220 according to a setting that has been made in advance. On the other hand, the control unit 170 may display a notification message in one of the first display area 210 and the second display area 220 based on a motion of one of the first display area 210 and the second display area 220. For example, if the second display area 220 is opened from the first display area 210, the control unit 170 may display a notification message in the first display area 210. Alternatively, if the first display area 210 is opened from the second display area 220, the control unit 170 may display a notification message in the second display area 220.

The control unit 170 determines whether a notification message is selected, in step 2527. For example, if a notification message is displayed in the first display area 210, as illustrated in FIG. 26A or 26C, and if the notification message is then selected in the first display area 210, the control unit 170 may sense the same. In this case, if a tap is sensed in the first display area 210 in response to the notification message, the control unit 170 may sense the same as selection of the notification message. If the notification message is selected, the control unit 170 displays the message content of the notification event, in step 2529. In this case, the message content may include identification information regarding the notification message and the notification event. For example, if the notification message has been displayed in the first display area 210, the control unit 170 may display the message content in the first display area 210, as illustrated in FIG. 26B or 26D. The method for operating the electronic device 100 may end therewith.

If the notification message is not selected, the control unit 170 determines whether the notification event is to be removed, in step 2537. For example, if a notification message is displayed in the first display area 210, as illustrated in FIG. 26A or 26C, and if removal of the notification message from the first display area 210 is then requested, the control unit 170 may sense the same. In this case, if a flick is sensed in the first display area 210 in response to the notification message, the control unit 170 may sense the same as a request for removal of the notification message. If the notification is not to be removed, the control unit 170 returns to step 2525. If the notification is to be removed, the control unit 170 removes the notification message from the display unit 130, in step 2539. The method for operating the electronic device 100 may then terminate.

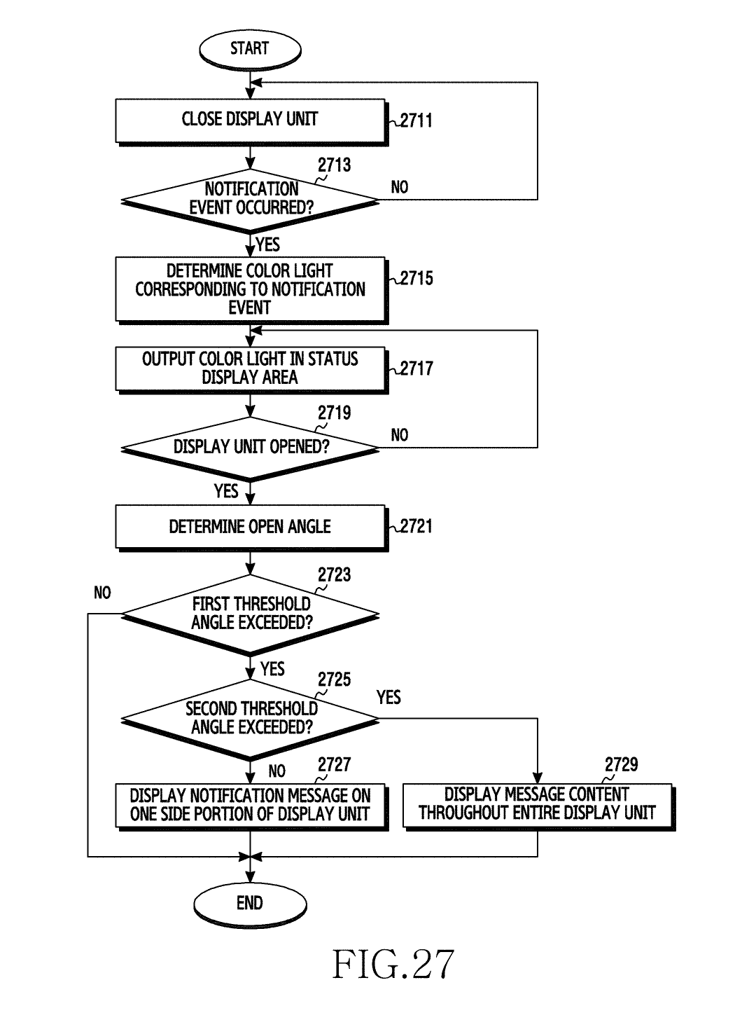

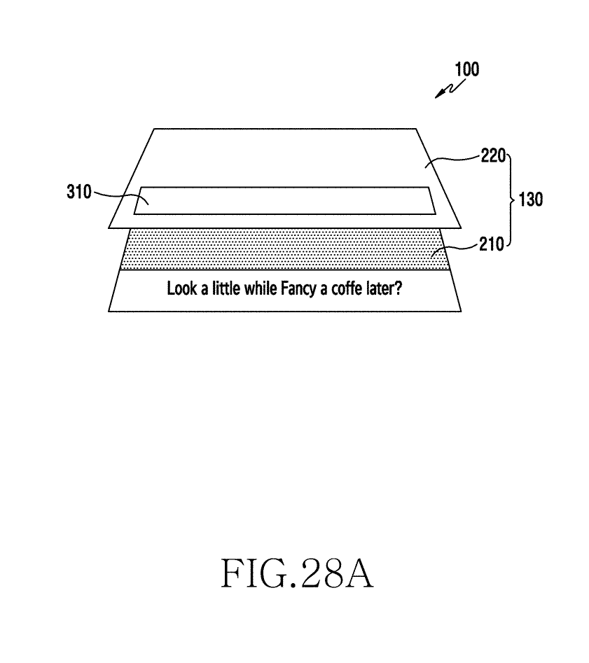

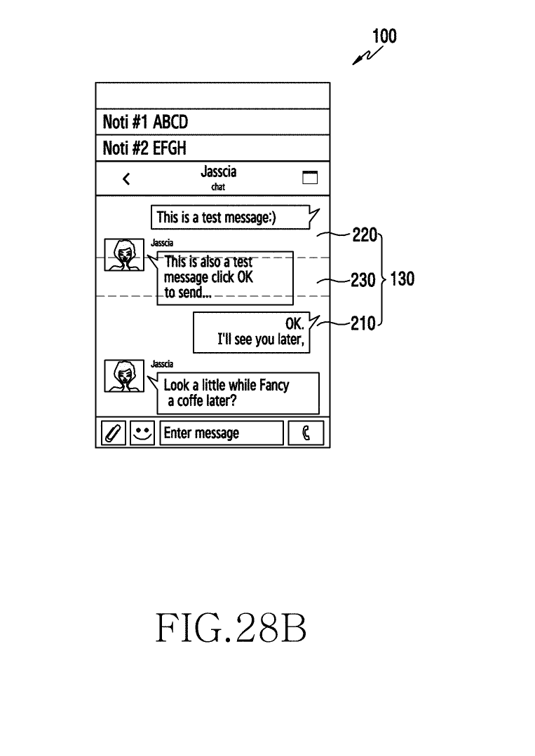

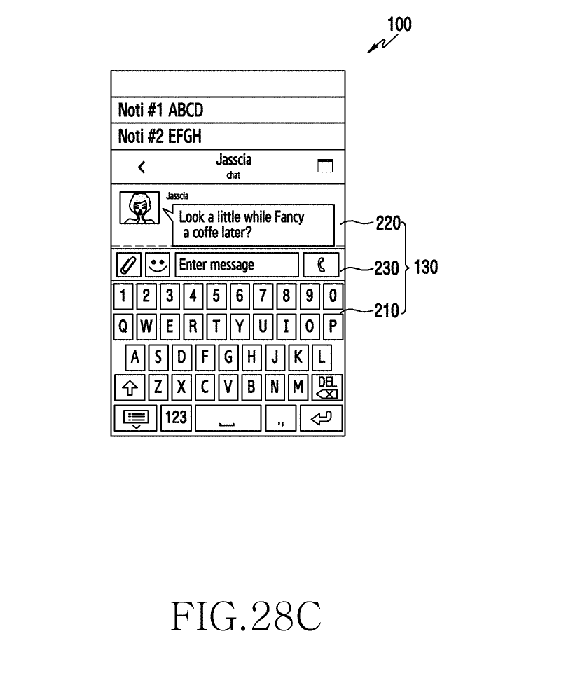

FIG. 27 is a flowchart illustrating an electronic device operating method, according to an embodiment of the present disclosure. FIGS. 28A-28C are diagrams illustrating an electronic device operating method, according to an embodiment of the present disclosure.

Referring to FIG. 27, the control unit 170 senses the closing of the display unit 130 by the control unit 170, in step 2711. In this case, the control unit 170 may sense a motion of the display unit 130 through a sensor unit 150. When the display unit 130 is closed, as illustrated in FIG. 4A, the control unit 170 may sense the same. For example, the control unit 170 may sense a motion of at least one of the first display area 210 and the second display area 220 through the sensor unit 150. Furthermore, the control unit 170 may detect the angle between the first display area 210 and the second display area 220 on the basis of a motion of at least one of the first display area 210 and the second display area 220. In this regard, the control unit 170 may determine, when the angle between the first display area 210 and the second display area 220 is less than or equal to 0°, that the display unit 130 is closed.

The control unit 170 may turn the display unit 130 off when the display unit 130 is closed. In this case, the control unit 170 may turn off the first display area 210, the second display area 220, and the status display area 230. Particularly, the control unit 170 may block a power supply to the first display area 210, the second display area 220, and the status display area 230. Alternatively, the control unit 170 may turn off the first display area 210 and the second display area 220, and may turn on the status display area 230. Particularly, the control unit 170 may block the power supply to the first display area 210 and the second display area 220, and may supply power to the status display area 230. For example, when the display unit 130 is closed while a function is being executed, the control unit 170 may turn off the first display area 210 and the second display area 220 and may turn on the status display area 230.

The control unit 170 determines whether a notification event has occurred, in step 2713. In this case, the notification event may include a communication event and a schedule event. For example, the communication event may occur in response to reception of a call, a message, or power. The schedule event may occur in response to arrival of a schedule or an alarm time.

If the notification event has not occurred, the control unit 170 returns to step 2711. If the notification event has occurred, the control unit determines a light color, which corresponds to the notification event, in step 2715. In this case, the control unit 170 may determine at least one of the color of the light, the output time interval, the output intensity, and the output type, according to the notification event. In addition, the control unit 170 may output color light in the status display area 230 of the display unit 130, in step 2517. In this case, when the status display area 230 is turned off, the control unit 170 may turn on the status display area 230 and output the colored light. For example, the control unit 170 may output a yellow light in the status display area 230 in response to originator A. Alternatively, the control unit 170 may output a blue light in the status display area 230 in response to originator B. Alternatively, when a call is received, the control unit 170 may output a green light in the status display area 230. Alternatively, when power is received, the control unit 170 may output a red light in the status display area 230.

The control unit 170 determines whether the display unit 130 is opened, in step 2719. In this case, the control unit 170 may sense a motion of the display unit 130 through a sensor unit 150. For example, the control unit 170 may sense a motion of at least one of the first display area 210 and the second display area 220.

If it is determined that the display unit 130 is not opened, the control unit 170 returns to step 2717. If it is determined that the display unit 130 is opened, the control unit 170 determines the open angle of the display unit 130, in step 2721. In this case, if the motion of the display unit 130 stops, the control unit 170 may detect the open angle of the display unit 130. As the display unit 130 is opened, as illustrated in one of FIGS. 4B-4F, the control unit 170 may detect the open angle of the display unit 130. For example, the control unit 170 may detect the angle between the first display area 210 and the second display area 220, i.e., the open angle, based on a motion of at least one of the first display area 210 and the second display area 220. For example, the open angle may be determined in such a range that is greater than 0° and is less than or equal to 360°.

Subsequently, the control unit 170 compares the open angle of the display unit 130 with a preset first threshold angle, and determines whether the open angle is greater than the first threshold angle, in step 2723. For example, the first threshold angle may be 0°.

If the open angle of the display unit 130 is greater than the first threshold angle, the control unit 170 compares the open angle of the display unit 130 with a preset second threshold angle, and determines whether the open angle is greater than the second threshold angle, in step 2725. For example, the second threshold angle may be 170°.

If the open angle of the display unit 130 is less than or equal to the second threshold angle, the control unit 170 displays a notification message on one side portion of the display unit 130, in step 2727. For example, the control unit 170 may display a notification message on one side portion of the display unit 130, as illustrated in FIG. 28A. In this case, the control unit 170 may turn on one of the first display area 210 and the second display area 220. In addition, the control unit 170 may display a notification message in one of the first display area 210 and the second display area 220. The method for operating the electronic device 100 may end therewith.

The control unit 170 may display a notification message in one of the first display area 210 and the second display area 220 on the basis of the open angle of the display unit 130. The control unit 170 may display a notification message in one of the first display area 210 and the second display area 220 according to a setting that has been made in advance. On the other hand, the control unit 170 may display a notification message in one of the first display area 210 and the second display area 220 based on a motion of one of the first display area 210 and the second display area 220. For example, if the second display area 220 is opened from the first display area 210, the control unit 170 may display a notification message in the first display area 210. Alternatively, if the first display area 210 is opened from the second display area 220, the control unit 170 may display a notification message in the second display area 220.

If the open angle of the display unit 130 is greater than the second threshold angle, the control unit 170 displays the message content throughout the entire the display unit 130, in step 2729. For example, the control unit 170 may display the message content, as illustrated in FIG. 28B. In this case, the message content may include identification information regarding the notification message and the notification event. Alternatively, the control unit 170 may display the message content as illustrated, in FIG. 28C. In this case, the message content may include identification information regarding the notification message and the notification event and a keypad. Alternatively, if the sub display area 310 is selected before opening of the display unit 130, the control unit 170 may display the message content, as illustrated in FIG. 28C. The method for operating the electronic device 100 may then terminate.

According to various embodiments, the electronic device 100 may have a flexible display unit 130 and thus may be implemented in a flexible manner. In addition, the electronic device 100 may be opened using the status display area 230 of the display unit 130 as a boundary. Accordingly, the electronic device 100 may control display data according to the open angle of the display unit 130. Particularly, the electronic device 100 may control display data in the status display area 230 of the display unit 130. As a result, the electronic device 100 may provide various interactions using the status display area 230 of the display unit 130.

The embodiments of the present disclosure disclosed herein and shown in the drawings are merely examples presented in order to easily describe technical details of the present disclosure and to help the understanding of the present disclosure, and are not intended to limit the scope of the present disclosure. Therefore, it should be construed that, in addition to the embodiments disclosed herein, all modifications and changes or modified and changed forms derived from the technical idea of the present disclosure fall within the scope of the present disclosure.

While the disclosure has been shown and described with reference to certain embodiments thereof, it will be understood by those skilled in the art that various changes in form and detail may be made therein without departing from the spirit and scope of the disclosure as defined by the appended claims.

What is claimed is:

1. An electronic device comprising:
a flexible display unit comprising a first display area, a second display area, and a status display area disposed between the first display area and the second display area; and
a control unit functionally connected to the flexible display unit,
wherein the control unit is configured to sense an opening of the closed display unit, to detect an open angle between the first display area and the second display area, and to determine status information, which is to be displayed in the status display area, based on the open angle.

2. The electronic device of claim 1, wherein, when the open angle is within a first angle range, the control unit is further configured to display a screen in at least one of the first display area and the second display area, and to display the status information in the status display area.

3. The electronic device of claim 1, wherein, when the open angle is within a second angle range, the control unit is further configured to display screens in the first display area and the second display area, and to display the status information in the status display area.

4. The electronic device of claim 1, wherein, when the open angle is within a third angle range, the control unit is further configured to display the status information on a side portion of the display unit, and to display a single screen on a remaining part of the display unit.

5. The electronic device of claim 1, wherein, when the open angle is within a fourth angle range, the control unit is further configured to display screens in the first display area and the second display area, and to display the status information in the status display area.

6. The electronic device of claim 5, wherein the control unit is further configured to rotate the first screen and the second screen such that upper end portions of the first screen and the second screen face the status display area.

7. The electronic device of claim 1, wherein, when the open angle is within a fifth angle range, the control unit is further configured to display at least one screen in at least one of the first display area and the second display area, and to display the status information in the status display area.

8. The electronic device of claim 1, wherein the control unit is further configured to identify a motion of at least one of the first display area and the second display area, and to determine the status information based on the motion.

9. The electronic device of claim 1, wherein the control unit is further configured to sense that the display unit is closed, and to output a colored light in the status display area.

10. The electronic device of claim 9, wherein the control unit is further configured to determine a color of the colored light in response to a sensed notification event, and to determine a color of the colored light in response to an executed function.

11. A method for operating an electronic device, comprising:
sensing an opening of a closed flexible display unit, the flexible display unit comprising a first display area, a second display area, and a status display area disposed between the first display area and the second display area;
determining an open angle between the first display area and the second display area; and
determining status information, which is to be displayed in the status display area, based on the open angle.

12. The method of claim 11, wherein, when the open angle is within a first angle range, further comprising:
displaying a screen in one of the first display area and the second display area; and
displaying the status information in the status display area.

13. The method of claim 11, wherein, when the open angle is within a second angle range, further comprising:
displaying screens in the first display area and the second display area; and
displaying the status information in the status display area.

14. The method of claim 11, wherein, when the open angle is within a third angle range, further comprising:
displaying the status information on a side portion of the display unit; and
displaying a single screen on a remaining part of the display unit.

15. The method of claim 11, wherein, when the open angle is within a fourth angle range, further comprising:
displaying screens in the first display area and the second display area; and
displaying the status information in the status display area.

16. The method of claim 15, wherein displaying the screens comprises rotating the screens such that an upper end portions of the screens face the status display area.

17. The method of claim 11, wherein, when the open angle is within a fifth angle range, further comprising:
displaying at least one screen in at least one of the first display area and the second display area; and
displaying the status information in the status display area.

18. The method of claim 11, wherein:
determining the open angle comprises identifying a motion of at least one of the first display area and the second display area, and
determining the status information comprises determining the status information based on the motion.

19. The method of claim 11, further comprising:
sensing that the display unit is closed; and
outputting a colored light in the status display area.

20. The method of claim 19, further comprising at least one of:
determining a color of the colored light in response to a sensed notification event; and
determining a color of the colored light in response to an executed function.
